(19) United States
(12) Patent Application Publication
(10) Pub. No.: US 2003/0025476 A1
(43) Pub. Date: Feb. 6, 2003

(54) Method of distributing widespread portable emergency cellular power and e-911 assistance

(76) Inventor: Richard Steven Trela, Clearwater, FL (US)

Correspondence Address: Richard Steven Trela, 100 Pierce Street #1101, Clearwater, FL, 33755, US

(21) Appl. No.: 10/134,541

(22) Filed: Apr. 30, 2002

Related U.S. Application Data
(60) Provisional application No. 60/288,144, filed on Apr. 30, 2001.
(60) Provisional application No. 60/328,057, filed on Oct. 9, 2001.
(60) Provisional application No. 60/328,019, filed on Oct. 9, 2001.
(60) Provisional application No. 60/327,916, filed on Oct. 9, 2001.

(51) Int. Cl. H02J 7/00

(52) U.S. Cl. 320/107

(57) ABSTRACT

A method of increasing public safety by supplying widespread portable power to the general public in order to recharge their cellular phones, while providing the tracking coordinates of it's users to e-911 authorities during emergencies or disasters. The method utilizes a portable emergency service devise equipped to re-charge or operate cellular phones, as well transmit an e-911 signal to authorities when activated by a public in need. FIG. 10 shows a person in need of e-911 service or emergency recharge power releasing the devise from it's housing and carrying the power and e-911 transmitter with him to an emergency situation. FIG. 33 shows the e-911 support of the invention in use in the field.

FIG. 6 shows a more commercial embodiment wherein the unit is made available to the general public in a variety of places such as bars, restaurants airports, etc. In this case the unit is sponsored by advertisers who sponsor the use of the unit by the public by being able to display their advertising message on the unit which is equipped to receive wireless transmissions that get converted to images and sound in the public view for all to see. This feature allows the unit to be offered free for all to use. Additionally in times where emergency power is not needed, the public can enjoy the convenience of recharging their phone “while out and about”, facilitating peace time or non-emergency communications via cellular phone. FIG. 31 Shows as well, that the unit allows for extended customer service in the field by answering one of the largest cellular user complaints of “their phone going dead in public” Manufacturer's can now by collective sponsorship of these emergency power units help provide the public with this vital new public safety and convenience devise.

### CROSS REFERENCE TO RELATED APPLICATIONS

This application is entitled to the benefit of U.S. Provisional Patent Application Nos. 60/288,144, filed Mar. 30, 2001, Application No. 60/328,057 filed Oct. 9, 2001, Application No. 60/328,019 filed Oct. 9, 2001, Application No. 60/327.916 filed Oct. 9, 2001, Application No. 29/149,224 filed Oct. 4, 2001

### STATEMENT REGARDING FEDERALLY SPONSORED RESEARCH AND DEVELOPMENT: NOT APPLICABLE

### BACKGROUND OF THE INVENTION

This invention generally relates to public utility devices designed to distribute auxiliary recharging electrical power and extended e-911 emergency calling capability, to the public in times of emergency, disaster or power outage. More specifically, a means of distribution of various quantities and types of recharge and or supply energy, for the purpose of recharging or operating a plurality cellular phones and other electronic devices in public places, during times of peace, or acting as an emergency power source during times of heightened alert, emergency power shortage or outage, times of enforced confinement, manmade or natural disasters or any other threats to civil or government cellular communication interruption due to cellular recharging power loss as well as providing wide spread tracking points for e-911 emergency calls.

### DISCUSSION OF THE RELATED ART

Prior art examples will be found to be limited as this invention answers major problems our culture has recently inherited due to the fact that world has been vastly changed by mobile communication now being made available to virtually everyone. Due to advances in cellular technology and low cost of production the use of cell phones and other personal electronics devises is evident virtually everywhere you go in the world.

### Ref: Technology News, Oct. 17, 2001

### Sandy Berger,

“From Stone Age to Phone Age “cell phones are becoming an integral part of our daily lives. It is no surprise that a groundbreaking study just released says mobile technology has permanently changed the way we work, live, and love”.

Reference: “On the Mobile” by Dr. Sadie Plant, “World Online” “The launch of a global-in-depth report entitled “On the Mobile” into the behavior of mobile phone users has revealed that the behavior of people around the world has been drastically influenced by the mobile phone”.

With the proliferation of cellular telephones and other handheld electronic devises into the society, many of the millions of cellular phone users have a need on a daily basis for a method to recharge their phone or electronic devise while they are away from their home or office and even more importantly in emergency situations. Many cellular customers experience their battery going low or “going dead” while “out and about”.

Increasing dependency on cellular phones in emergency situations, as the means for reporting or supplying ongoing emergency status to authorities is today, routinely seen on many fronts.

### Ref: USA TODAY Oct. 23, 2001

### By John Yaukey Gannett news service

“The events of 911 demonstrated how helpful mobile phones can be in an emergency. There are numerous accounts of victims and survivors of the terrorist's attacks making critical calls to friends and family over cellular networks”.

Ref. “Mustang Daily Online” Nov. 1, 2001 by Jenni Mintz “Cell phones also provide safety in an emergency, allowing people to contact help when they are far from a pay phone or society”.

### Ref. “Cellular Phone News”

### www.cellularphonenews.com

“Cellular phones are important devices for reporting emergencies”. One is hard pressed today to not hear of, or experience, an instance wherein a cellular phone was used in an emergency situation to assist in contacting family for help or emergency authorities in life threatening emergency situations.

A major limitation on cellular phones and other portable electronic devises is battery life. Currently cellular phone users and handheld electronic devise users are resorting to carrying A/C charging adapters with them while away from home and while out in public places, having to find an A/C receptacle to plug in their charger, often necessitating sitting on the floor of an airport or seeking a remote comer of a restaurant to plug in their charger in a most inconvenient manner.

Additionally, in a true emergency situation the A/C power to supply to the charger may have been cut off eliminating a way to recharge the phone and thus threatening the emergency communication use of the cell phone or other electronic devise. Feng-Jung, Tu (U.S. Pat. No. 6,191,553), sought a way to handle this problem by using a belt clip attachment to carry a portable power supply but it's design was applicable only to personal not widespread public use and was limited due to it's power supply potential. Malaspina (U.S. Pat. No. 5,544,784) addressed the battery life issue and tries to solve it by vending recharged batteries. This proposed solution is complicated by the various sizes and shapes and electrical characteristics of the many batteries on the market. Some vending machines have also been identified for the purpose of charging electric vehicles. These devises however, incorporate battery-charging circuitry capable only of charging car batteries and not cellular phones or other personal electronic devises and require attachment to the mains to function eliminating their use during power outage.. Further these examples of prior art devices are impracticable from the standpoint of size and function to be of widespread value in solving societies' worldwide need of widespread public access to cellular and electronic devise recharging energy while in the work-a-day world. Small personal devises for recharging cell phones have been developed such as a small handheld generator, a disposable battery device, even a key chain size battery supplements, but are made for personal use, have extremely limited charging or support capability, and are not at practical for handling the widespread needs, of the general public for normal, or emergency recharge power support.

### SUMMARY

The invention solves the ever-growing universal problem of cellular phones going dead out in public by providing a convenient and practical means of distributing cellular recharging power to the general public. The invention increases the standard of living for society by providing the additional public utility of widespread cellular recharging power for use in the event of emergency or for use to make life easier. The essence of the invention is “bring the power to you, instead of you going to the power”. This factor is accomplished by a unique use of circuitry, power sources, and embodiments that combine into an extremely practical means of supplying portable emergency power to the public. Further, the invention carries it's weight economically by allowing the widespread distribution and use of the product to be financed by collective sponsorship by cellular phone manufacturers, service providers or unrelated industry advertisers via an electronic advertising system incorporated into the embodiments of the invention. In actual practice, this aspect to the invention has been proven extremely popular in no small measure by the fact that the advertiser not only gets the undivided attention of it's intended public but also the advertiser is credited with has the added value the consumer of providing a pubic service to the society sponsoring this vitally needed public utility. Further, this aspect of the invention allows municipalities and governments to provide these new cultural and emergency benefits to society without the need to use tax dollars that may be vitally needed elsewhere. Additionally the e-911 calling capability of the invention allows emergency access to authorities, even to non-cell phone users. Currently the public can rely on payphone to report emergencies, however at this writing pay phones are rapidly going obsolete and in some area impossible to find making emergency reporting via pay phone a cultural benefit a vanishing public service. This invention along with many other innovations and advantages outlined in the rest of this submission solve many problems in society arising from our new techno-cellular cultures developing worldwide.

### OBJECTS OF THE INVENTION

This invention makes possible the practical delivery of a vitally needed, new public utility on the order of magnitude of, let us say, the public pay phone. The public can now benefit from the everyday convenience of being able to access emergency source of recharge power for their cellular phone or other electronic devise while out in public, i.e. out at a restaurant, waiting for an airplane, or train, at a sporting event amusement park or virtually anywhere the devise is located. This invention is a new method of providing the public a standard source for accessing recharging power for normal convenience use, or emergency recharge power use, by providing cellular phones users the exact mechanical/electrical connection and electrical recharge energy, in the properly regulated amount needed to recharge their model phone or electronic devise while out at a public place.

The invented machine generally relates to public utility systems and devices wherein a widespread need is satisfied with a resulting cultural benefit and increased standard of living, and in the case emergency possibly survival. Examples, such as the invention of the public pay phone system or the urgent development of the e-911 emergency call* system, are examples of the widespread use the described invention is designed to cover) With the importance of making available recharging power to everyone during an emergency in mind, this invention is designed to be sponsored by corporate sponsors or supplied by government agencies, or in some casesswherein a form of point of use payment for convenience charging is incorporated, the inventions' design incorporates a payment over ride system to enable emergency use without the need of a monetary exchange at the point of use. Included in the design is a built is cellular phone, enabling a user, a “free of charge” 911 or e-911* emergency call if needed.

Reference: USA Today Oct. 23, 2001

Now slated for wide release in society by 2005 wherein rescue workers would be able to track victims carrying cellular phones within as close as 50 yards.

This inventions objects, are now more than ever needed in society. An in depth study conducted by mobile industry leaders Motorola, commissioned Dr. Sadie Plant, leading author and pioneer of the Cybernetic Culture Research Unit at the University of Warwick, to look at groups of mobile devise users in cities across the world. Her in depth report entitled “On the Mobile” describes a growing increase in concern by the public “of being out of touch.” Supporting her claims by actual experiment, this invention brought to public places for use, was routinely met by a large cross section of the public with the reactions 1) “surprise it was invented” and 2) “relief it was there”, as enabling recharge power out in public when needed, gave, according to public surveyed, along ““with we needed this !' and “great idea”, people “an extra sense of security” in our uncertain, changing times.

This invention as well as being a very important cultural advance for society greatly assists the cellular phone/electronics industry by enabling these companies to extend customer service in the field, by addressing one of the largest complaints of cellular phone users, “phones going dead or restricted use of service due low battery reserve”. This invention allows for the rapid expansion of a brand new public utility service facility that is born out of the needs arising from our changing culture.

The world has gone cellular and will, according to all present observations, continue to go more so. Currently millions of people worldwide now use cellular phones. A daily problem of “running out of charge” occurs very commonly. This invention answers a constantly growing need that cell phone users have-to get their phone charged up when the battery goes dead. Just as a car needs gas, a cell phone needs electricity to continue to run. If a person is away from their home or personal charging devise and their cell phone goes dead, they go out of telephone communication. Business, family and emergency communications get interrupted until-they get to their charger. Some people carry extra batteries, but this is not everyone and they are cumbersome. A chance to get your phone recharged while out, away from home in the public, while dining, traveling, waiting for a plane or many other possible places where a person might find the opportunity to recharge, is a cultural benefit that's time has come with this invention.

Until now, there has been no user friendly widespread capability that enables the public method of securing recharge energy or recharging a cellular phone or other electronic devise while in a public place away from home. This invention provides the first charging station that can be accessed while at a restaurant, a bar airport, on an airplane, hospitals, emergency sites, etc., that enables a person to conveniently recharge their phone and not have to experience interruption or curtailed use, due to their phone going low on charge or ceasing completely due to their phone going dead. This invention fills a true need arising from our changing times.

### ADVANTAGES OF THE INVENTION

The overwhelming immediate success and acceptance by society of the invention further validated the fact that there has been a strong long felt need for a convenient method to recharge cellular phones and other devices by people out in the public environment. As dependency of cell phones becomes more and more prevalent the pay phone industry is rapidly dieing. Every year, thousands of pay phones are being removed from the society. Herein lies and unforeseen problem, wherein society actually over time will become enormously if not completely, dependent on the cell phone for social and emergency communication.

This invention answers the unforeseen problem of how to increase cellular charging capability, so as to ensure continuous communication and emergency communication as cell phone use increases over the years, and public pay phones a currently reliable way to report emergencies, become more and more scare or obsolete. It is a definite advantage of the invention that the public access to the power supplied by the unit is free in the event of emergency, as any monetary collection means is immediately by passed by the user in an emergency.

The social advantages, of not having to curtly cut off in the middle of a phone call to “get off the phone because your battery is going low” or the security of knowing that to reach a loved one, “even though your battery is dead”, you can find a public recharging source to put you back in communication are a couple more of advantages that are being appreciated as the invention proliferates in society.

Another advantage that is, by use, becoming recognized is that the invention is, in an alternative, more versatile embodiment, completely portable and allows the user to bring the unit to him so as to enable him to directly care for his phone; virtually eliminating the possibility of theft, as it is in his direct control at all times during the recharging cycle. As happens currently in society regularly, the public is burdened by having to bring his or her own personal charging unit to the public place and quite commonly having to ask someone such as a bartender to plug in for him. If not that scenario he has to take a chance of leaving his phone unattended while it charges in some remote place where a very, inconvenient, AC outlet is provided.

Another advantage that the invention addresses and solves is the inability of cellular phone companies to address a long felt need of their products' “in use failure” due to power failure while customers are out in the field. Increasing cellular phone minute usage because access to recharge is now available to the public out in the field will, over time, become more and more, achievable, as cellular charging stations proliferate the society.

### DRAWING FIGURES

FIG. 1-Shows the external housing of the cellular recharging station.

FIG. 2-Shows the external working parts of the cellular recharging station.

FIG. 3-Shows the bottom view with the external power contact points.

FIG. 4-Shows the companion charging base for recharging the cellular recharging station.

FIG. 5-Shows how the charging base and the and the charging station make electrical contact when mated.

FIG. 6-Shows the charger on it's companion charging base in public use displaying an electronic billboard message on an LCD screen.

FIG. 7-Shows the charger in use recharging a phone in public while operating under it's own power away from the recharging base for the convenience of the customer.

FIG. 8-Shows both the charger and the charger base in a typical use scenario in public. portable charging with LCD ad display showing advertisements and recharging base separate and away while phone charger is in use.

FIG. 9-Shows the charging station in a emergency booth style embodiment.

FIG. 10-Shows a side angle perspective of booth-style embodiment.

FIG. 11-Shows a person doing the first step of releasing the cellular charger from the housing in order to take it to the emergency situation.

FIG. 12-Shows a person doing the second step of releasing the cellular charger from the housing in order to take it to the emergency situation.

FIG. 13-Shows a person doing the removal step of releasing the cellular charger from the housing in order to take it to the emergency situation.

FIG. 14-Shows the charging unit being taken to an emergency situation.

FIG. 15-shows the bottom of the charging unit with the holding rod receptacle attached as well as with the electrical contact points for recharging energy transfer and unit slide in guides.

FIG. 16-shows negative and the positive contact points and the female slide and support assembly for the removable charging unit

FIG. 17-shows the action of the release lever assembly allowing the charger to be released..

FIG. 18-shows the components of the recharging base of the portable unit.

FIG. 19-shows an exploded view of the charging base spring loaded current transfer assembly.

FIG. 19-a shows wide target contact points for easy re docking of the unit still allowing for excellent current transfer between units.

FIG. 20-is a bottom view of the cell phone charger electrical contact base assembly.

FIG. 21-is a view illustrating the mating contact points between the charger unit and .the base

FIG. 22-is a wiring diagram of the charging base

FIG. 23-is a wiring diagram of the charging unit power supply

FIG. 24-is a wiring diagram of the charging block for the emergency pull out charger

FIG. 25-is an exploded view of the charging block assembly

FIG. 26-shows the central power distribution housing and external wiring arrangement

FIG. 27-shows central charging housing with external wiring illustrated

FIG. 28-is a schematic drawing of the motherboard circuitry

FIG. 29-is a exploded view of the motherboard circuitry

FIG. 30-is flow chart showing advertiser sponsorship allow broad distribution of this new public utility without need for government financial support if necessary.

FIG. 31-Shows a brand new system of business that allows cellular phone companies a way to practically deliver extended customer service in the field and solve one of the number one complaints of cell phone going dead in public without away to re charge.

FIG. 32-shows the sequence of the wireless adverting system

FIG. 33-Shows the e-911 capabilities of the invention

### REFERENCE NUMERALS IN DRAWINGS

Note: Numbering begins with 10.

10 external housing of portable emergency cellular charging station

11 top surface of unit

12 electronic cord distribution bays

13 external advertising panels

14 cellular phone being recharged

15 electrical connector

16 retractable charging cable

17 control panel

18 e-911 external microphone/speaker assembly

19 e-911 call button

20 card reader device

21 LCD screen

22 LED attention light

23 Charging status light

24 charging station base

25 12 volt and 8 volt positive circuit contact point

26 8 volt negative circuit contact point

27 12 volt negative circuit contact point

28 charging base structure

31 charging status indicator light

32 charging status indicator light

33 8 volt negative current supply spring

34 12 volt negative current supply spring

35 A/C power cord for the charging base

36 Emergency charging station housing

37 Release lever

38 Release lever upward movement

39 Release lever push in action

40 Pull out action of the emergency charging unit

41 Person leaving to emergency situation

Note: Numbering resumes with 56

56 bottom view of charging station

57 positive contact plate

58 negative contact plate

59 negative contact plate

60 locking pin sleeve

61 positive spring loaded contact point

62 negative spring loaded contact point for recharge circuit

63 negative spring loaded contact point for auxiliary power circuit

64 female slide support assembly

65 down action stop feature

66 main locking mechanism plunger shaft

67 downward motion of release mechanism

68 pivot pin

69 roller pin

70 slider channel

71 charging base top lid

72 bottom lid

73 base support legs

74 12 volt trickle charger

75 120/8 volt transformer

76 120 volt fluorescent

77 120 VAC power cord

78 spring loaded contact assembly

78-a miss margin illustration

78-b off target placement illustration

78-c supply wire

79 rolled edge contact tip

79-a 4 volt lead acid battery

79-b 4 volt lead acid battery

79-c 4 volt lead acid battery

80 rectifier diode

81 charging block structure

81 base structure

83 current transfer wires

83 current transfer wires

83-1 Wire fastening nut

83-a negative supply line

83-b positive supply line

84-on shot timer 12 volt-15 minute

85-switch terminal of 84

86-switch terminal of 84

Note: number skip

88-Momentary switch

88-a Switch wiring

90-Mini charging circuitry

91-voltage regulator circuit

91-b switch terminal on one shot timer

91-c switch terminal on one shot timer

95-e 911 cellular unit

96-optional headset

97-FCC mandate to have e-911 service

98-e-911 access thorough invention

99-emergency location transmission

100-help being sent to location

### DRAWING FIGURES

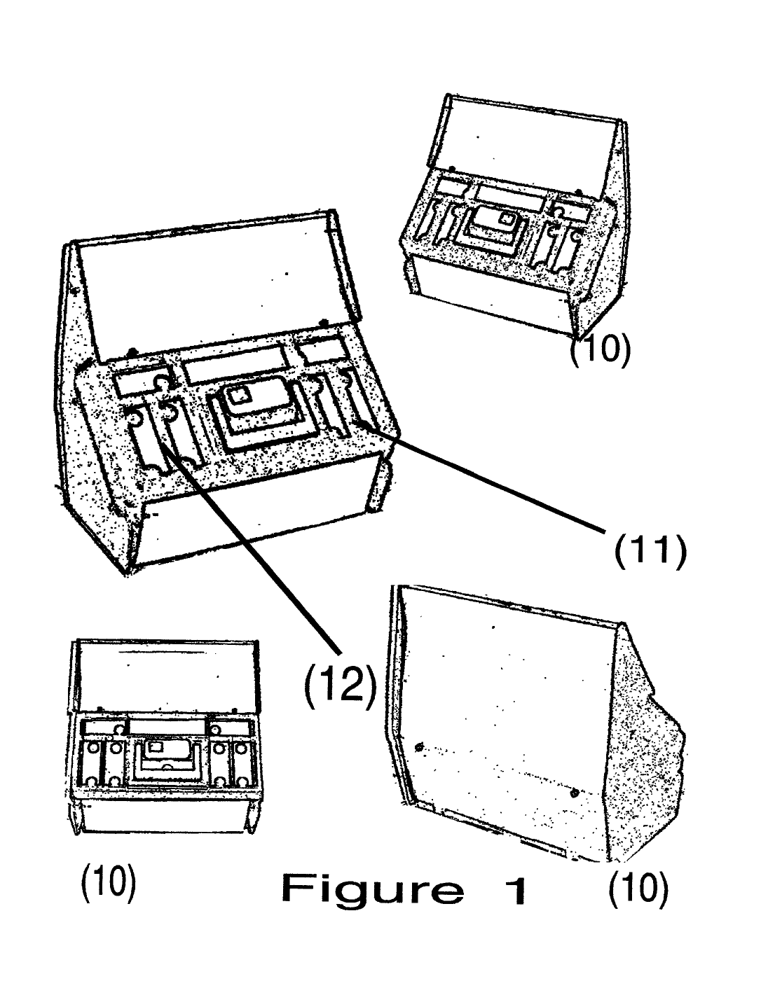

FIG. 1-Shows various external aspects of the housing and structural shape of the portable version of the of the invention 10 constructed in accordance with the invention. The upper surface of the vending apparatus 11 has multiple electronic cord distribution bays 12. These bays are designed to divide and separate cellular phones and other electronic device charging cords while they are being used, or waiting to be used for recharging cellular phones or electronic devices. 13 indicates external advertising panels for sponsor messages.

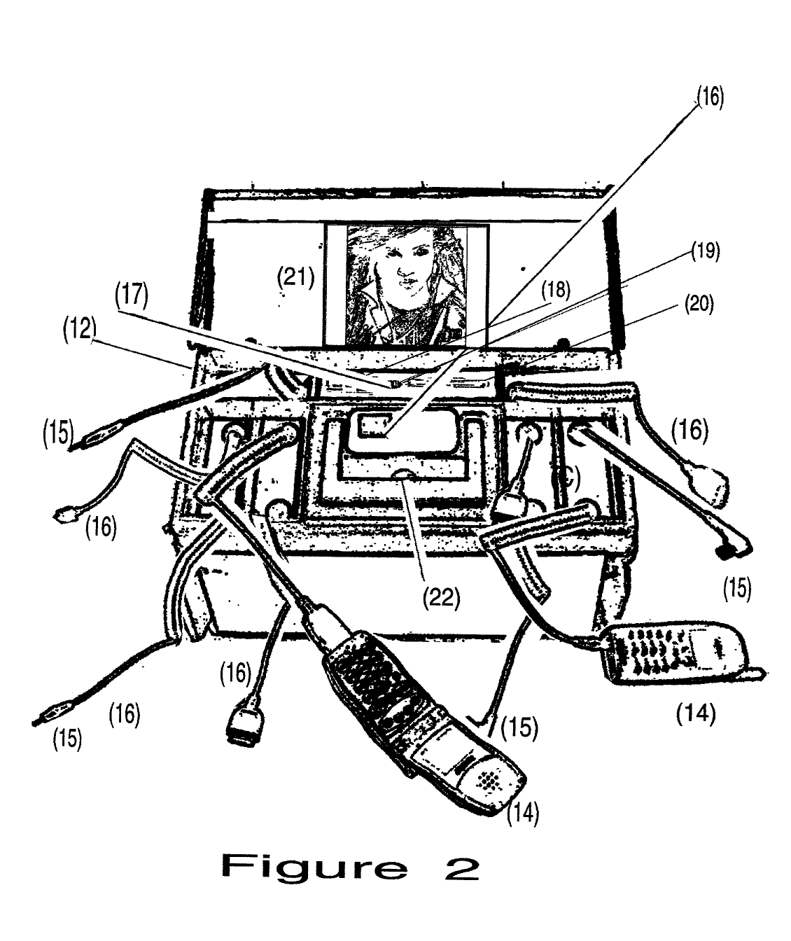

FIG. 2-is a further illustration of the components of the invention. In accordance with the invention electrical power is distributed via electrical cables 16 that are wired into the machine body and accessed through the electronic equipment holding bays 12. These electrical charging cables 16 have the purpose of supplying electricity to recharge the batteries on various model cellular phones 14 and other electronic equipment. At the end of each charging cable 16 is an electrical connector 15. Since there is a need to accommodate the recharging of various model cellular phones and electronic equipment on the market, each of the charging cable connector ends 15 are different and designed to hook up to, and charge it's intended model companion phone or electronic devise. This allows the owners of many different types of cellular phones and other electronic devises made by various manufacturers the capability of recharging their devise at the public location of the invention. 16 points out the charging cycle start switch..17 control panel housing an external microphone/speaker 18, a 911 emergency call button 19, and a card reader devise at 20. 21 shows a full color LCD screen capable of showing movie trailers etc. 22 in an LED “attention light” and 23 is an “charging status” indicator light.

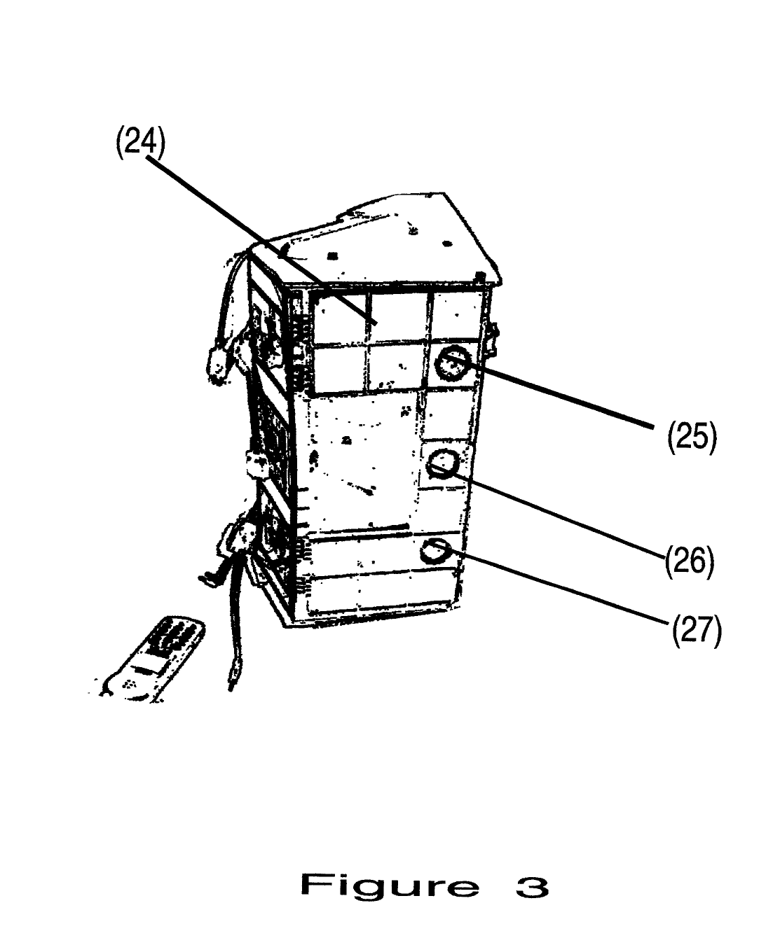

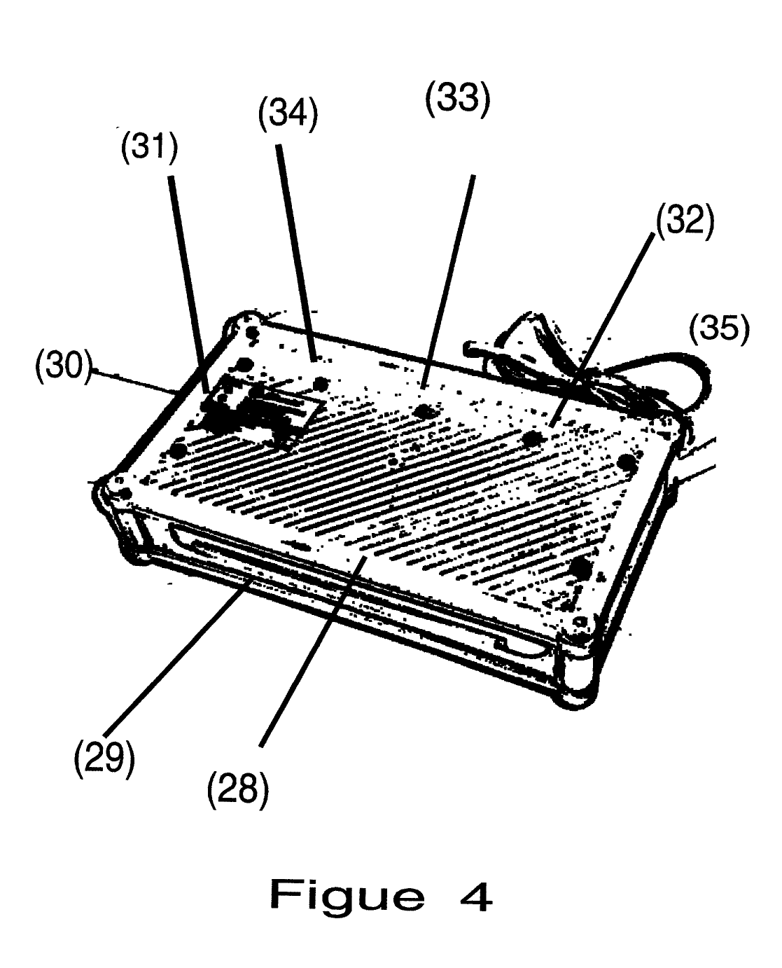

FIG. 3-Is a bottom view of the invention. 24 is the charging station base surface. 25 is the 12 volt and the 8 volt positive circuit contact. 26 is the 8 volt negative circuit contact, and 27 is the 12 volt negative circuit contact.

FIG. 4-Is the charging base that recharges the public cellular phone recharging station. 28 is the charging base structure. 29 is a back light for signage 30 is a rolled edge for guiding the public cellular charging unit properly onto the charging contacts. 31-a is the charging status indicator lights for viewing the state of charge of the cellular phone recharging station. 33 is the 8 volt and the 12 volt positive supply spring loaded connector plunger. 32 is the 8 volt negative supply spring loaded power connector plunger and 31 is the 12 volt negative supply spring loaded power connector.35 is the A/C power cord for the charging base.

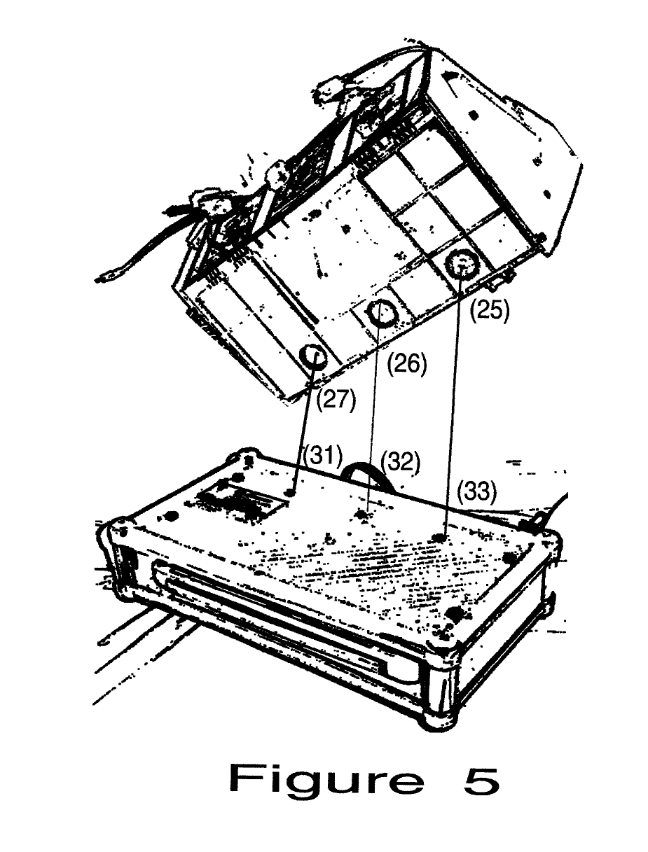

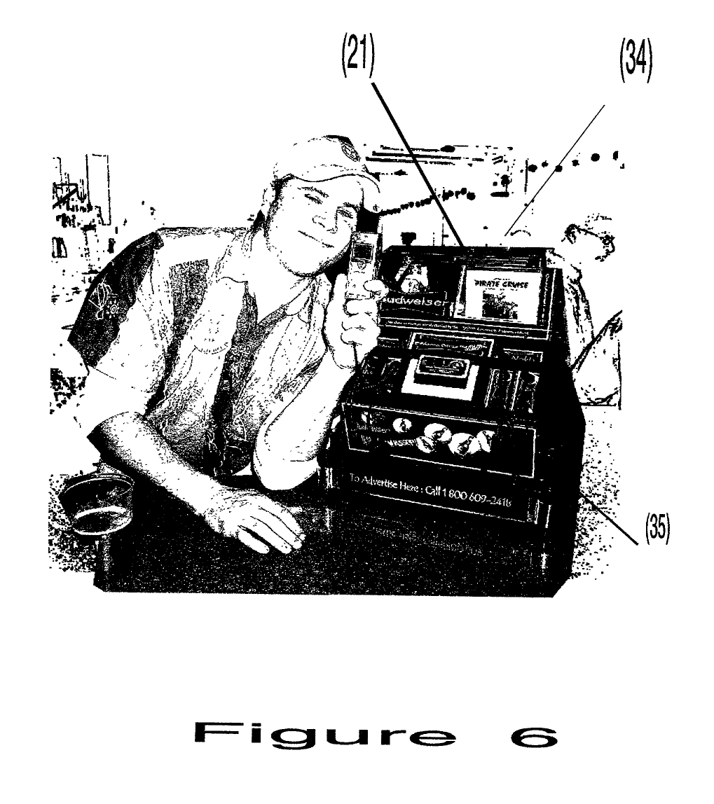

FIG. 5-Is an illustration showing how the cellular charging station seats onto and directly aligns the plunger contact points of the charging unit with the mated base surface of the cellular charging unit connecting points 27 with 31 completing the 12 volt negative charging circuit, the connecting points 26 and 32 completing the 8 volt negative supply circuit and points 25 and 33 completing the shared common positive circuit of the 8 volt and the 12 volt circuitry needed to recharge the cellular charging station itself, as well has power the LCD advertising screen.

FIG. 6-Shows the cellular charging station in public 34 and the charging base 28 mated as would be in a working capacity seen out in the public. The charging base would be charging the cellular recharging unit as needed and as well as providing direct power to operate the LCD advertising screen 21.

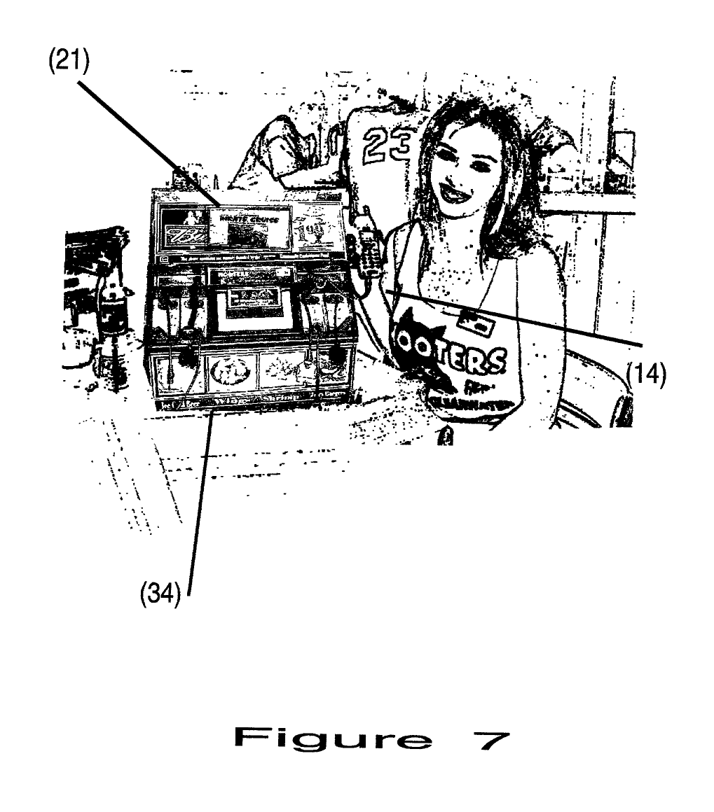

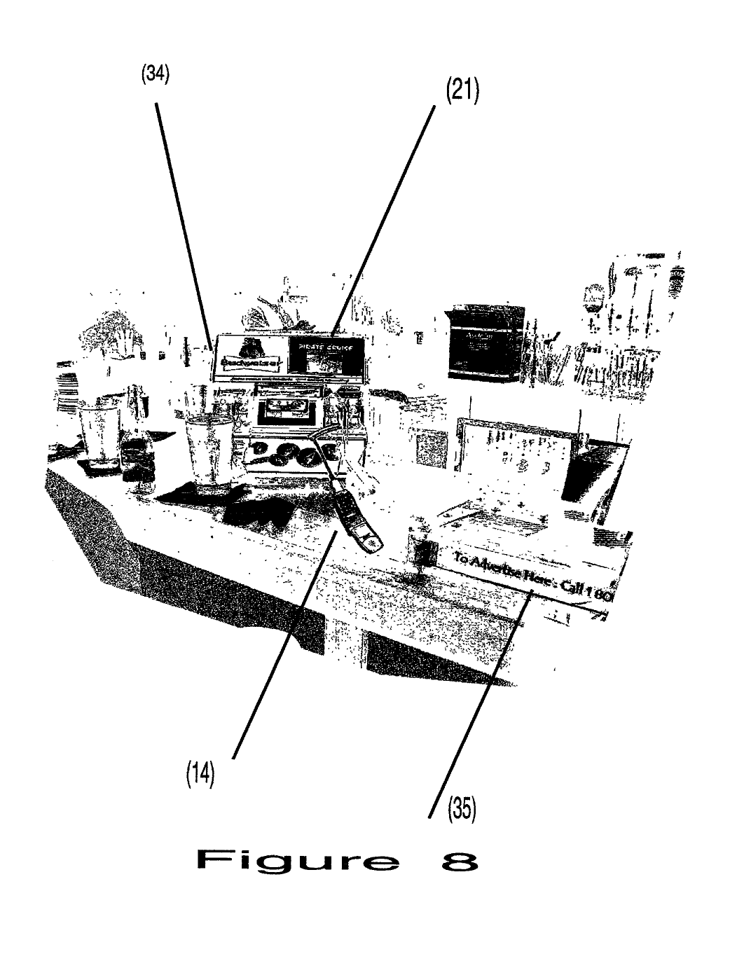

FIG. 7-Shows the recharging unit 34 in use in out in the public separated from it's charging base for user convenience as well as still providing advertisement display via the LCD screen. 21 under it's own power. 14 shown a cellular phone being recharged in public while remotely being under the direct control of the user.

FIG. 8-Shows the recharging unit 34 next to the charging base 28 illustrating the convenience of being able to place the charging base where convenient near an A/C outlet but being able to take the charger where it will be seen for advertising purposes 21 and used for recharging purposes 14.

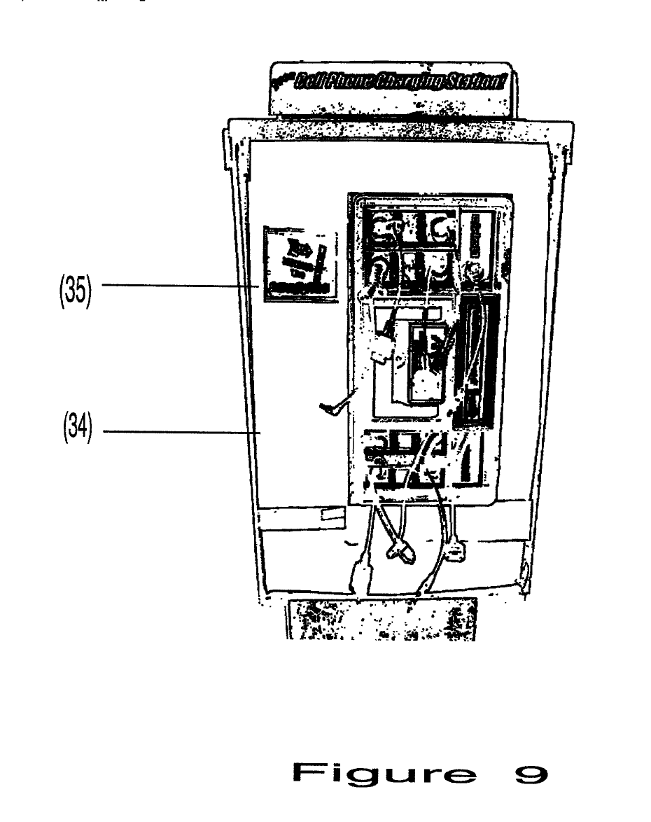

FIG. 9-Is an illustration of a cellular charging station with an emergency breakaway system enabling the public or authorities the ability to remove a portable charging unit from it's public housing in order to service a remote emergency situation.. 36 is a another embodiment of the invention designed to be installed in more general public areas of society such as locations commonly housing public pay phones. 37 is a release lever over the emergency release mechanism.

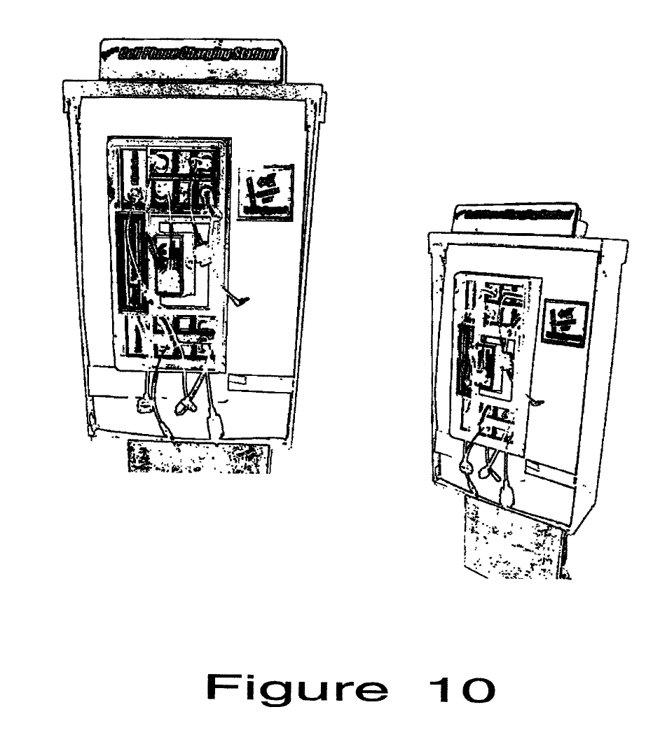

FIG. 10-Shows a side perspective as well as a front view.

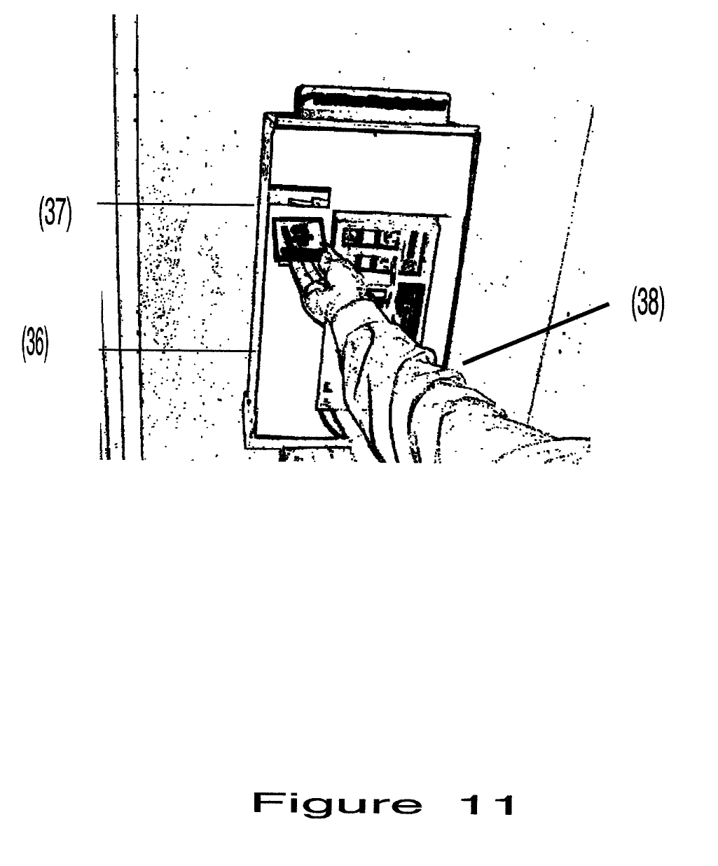

FIG. 11-Illustrates the first step in releasing the portable emergency power unit from it's housing to be taken for emergency use. 36 points to the housing 37 points to the release lever mechanism and 38 shows the push up action of the mechanism that allows the charging unit to be released.

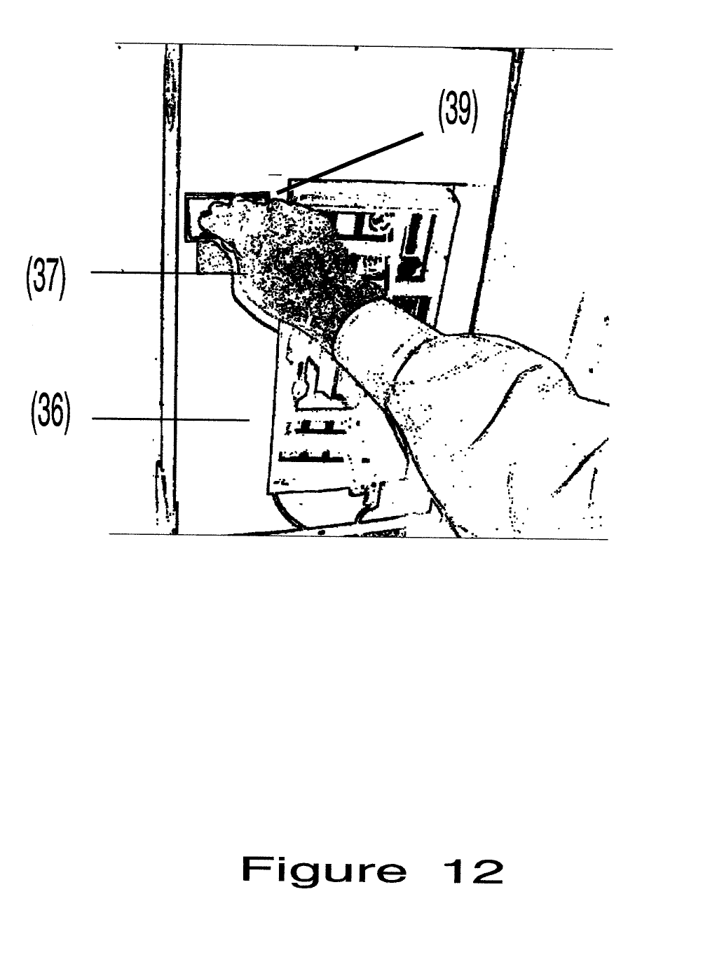

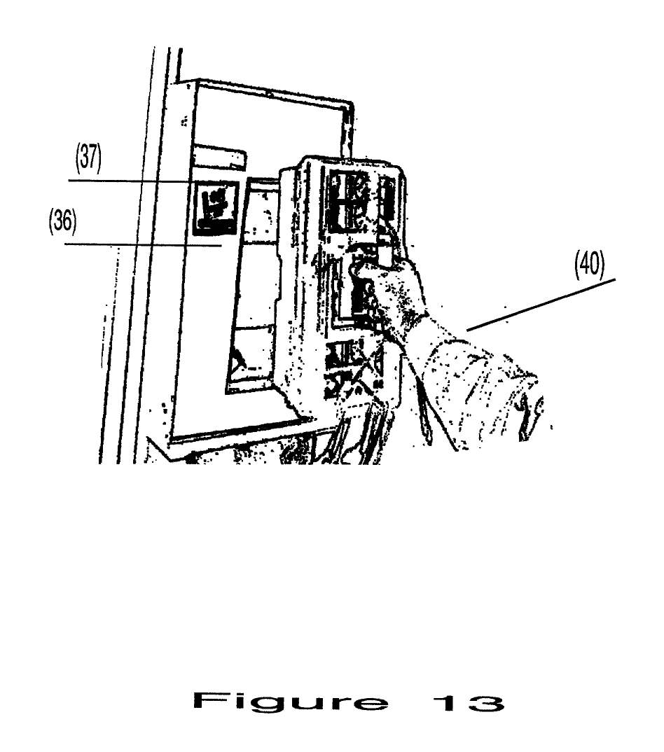

FIG. 12-Illustrates the second step in releasing the portable emergency power unit from it's housing to be taken for emergency use. 36 points to the housing 37 points to the release lever mechanism and 39 shows the push in action of the mechanism that allows the charging unit to be released.

FIG. 13-Illustrates the third step in releasing the portable emergency power unit from it's housing 36 to be taken for emergency use. 37 points to the release lever mechanism and 40 shows the pull out action of the mechanism that allows the charging unit to be released from the housing.

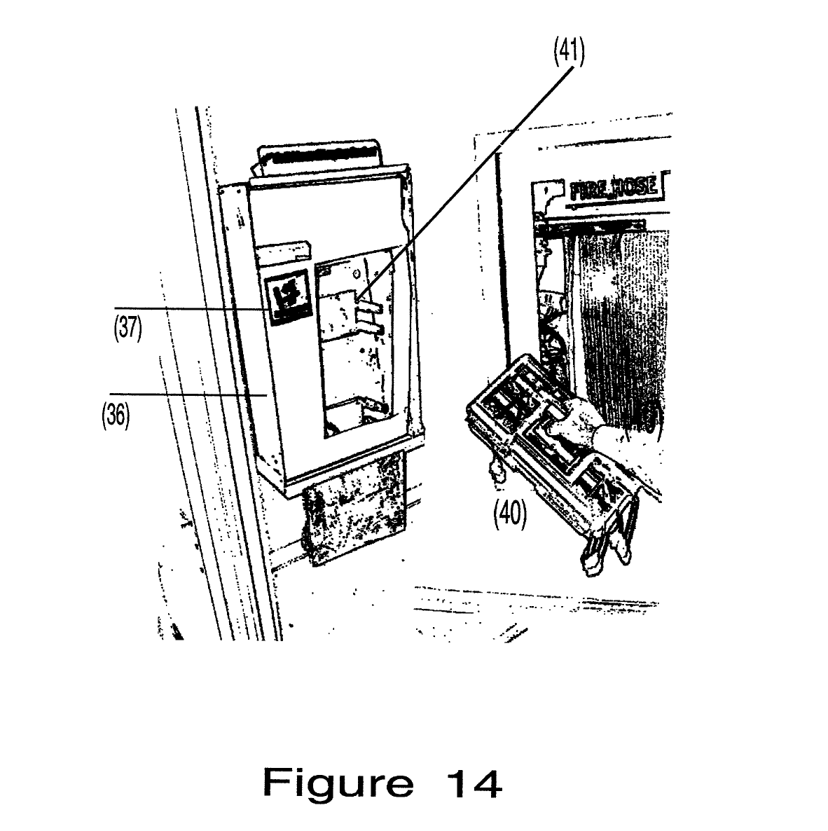

FIG. 14-Illustrates the third step in releasing the portable emergency power unit from it's housing to be taken for emergency use.. 36 points to the housing 37 points to the release lever mechanism and 41 shows the person taking the unit away to the emergency situation.

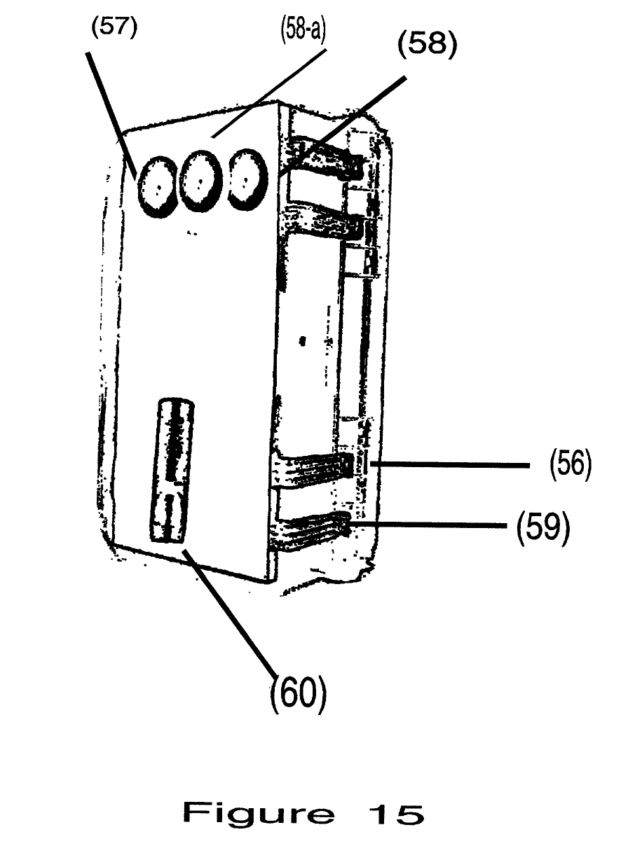

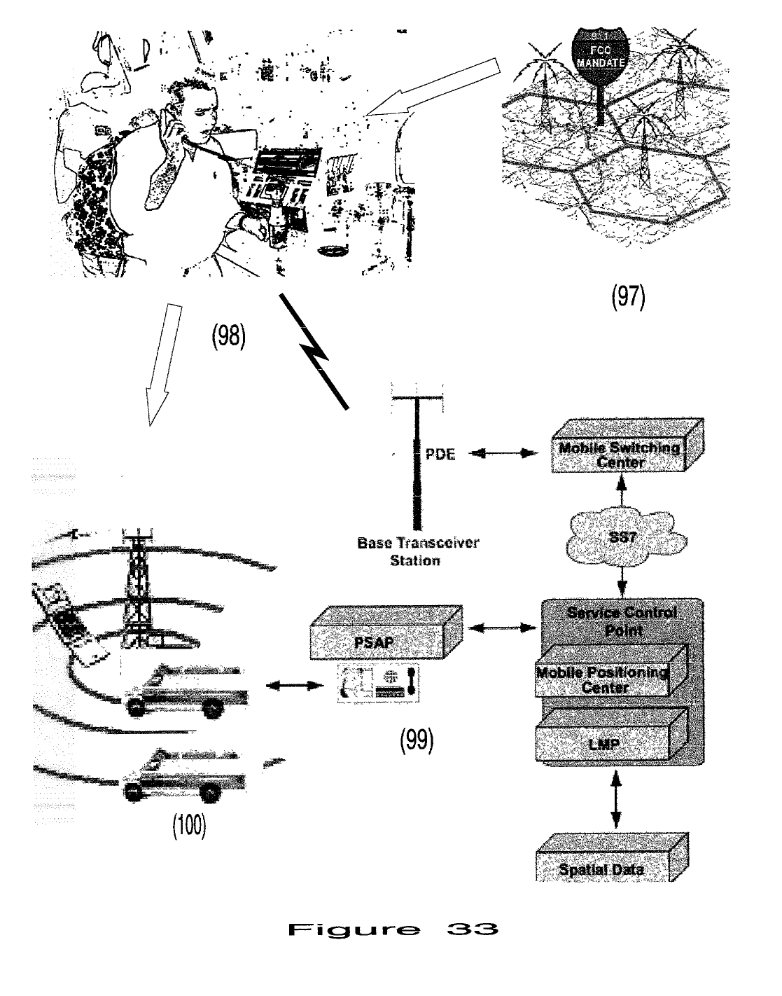

FIG. 15-56 shows the bottom of the removable charging station and the 57 is the positive contact plate for voltage transfer from the housing to the unit and 58 and 58-a are is the negative contact plates for voltage transfer to the unit for operating and recharging purposes of the cellular charging station. 59 is the male side of a guide channel assembly guide and support the removal and installation of the unit. 60 is the locking pin receiving sleeve.

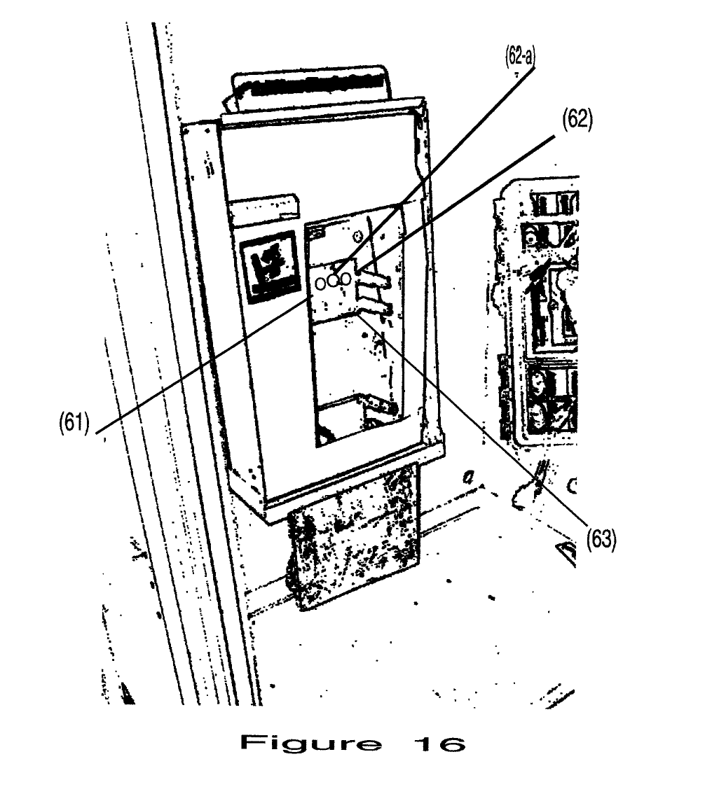

FIG. 16-61 is the positive spring loaded contact point and 62 is the negative spring loaded contact point for supplying recharge and operating energy for the removable charging unit.62-a is the negative contact point for auxiliary power. 63 is the female slide support assembly that supports the unit and allows for easy removal and installation. and 63-a is the charging block housing and the charging contact point assembly for recharging and powering the pull out unit.

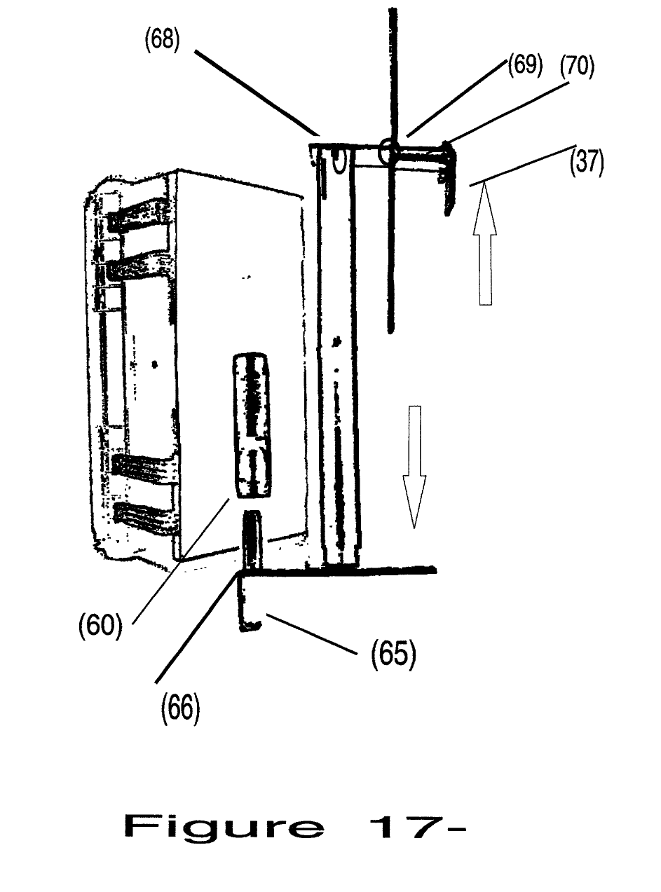

FIG. 17-60 shows the locking pin receiving sleeve and 64 shows the locking pin that slides up to lock in the unit. 65 is the down action stop feature. 66 is the main locking mechanism plunger shaft. 68 is a pivot pin that connects 37 the release lever push rod. 69 is a roller pin that allows the lever to slide out from it's pushed in position and act as a lever to lower the main plunger and thus activate the release of the main locking pin allowing the unit to be free from it's docking position. 70 is the slider channel the roller pin glides on.

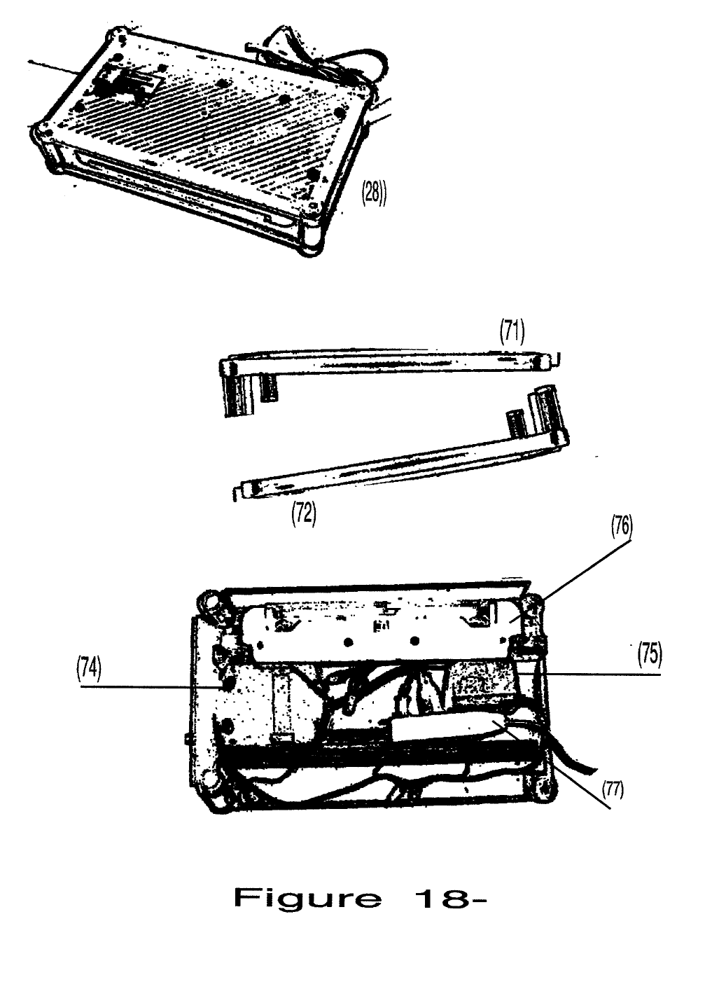

FIG. 18-28 shows the assembled charging base ready for use. The lid 71 and the base 72 are supported by legs 73. 74 is a conventional 120/12 volt trickle charger with a charging state circuit that stops charging when the battery voltage reaches approx 14 volts D/C.

75 is a conventional 120/8 volt transformer for powering the LCD screen when the charging unit is mated the charging base. 76 is a 120 volt fluorescent light fixture.77 is a standard commercial three outlet 120 volt A/C cord. is a standard commercial three outlet 120 volt A/C cord.

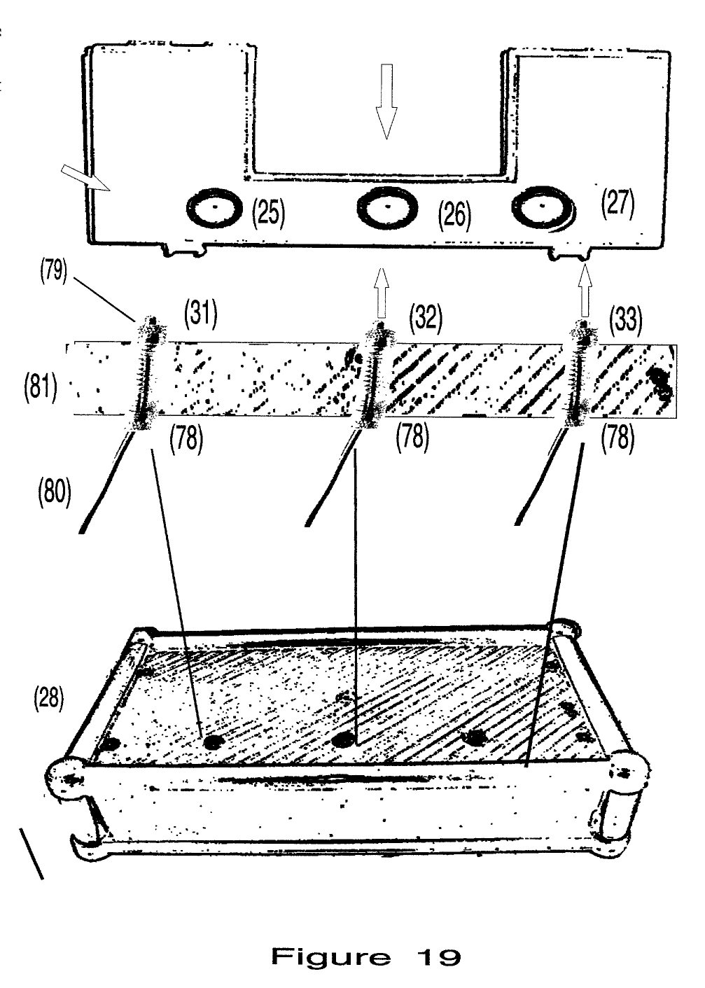

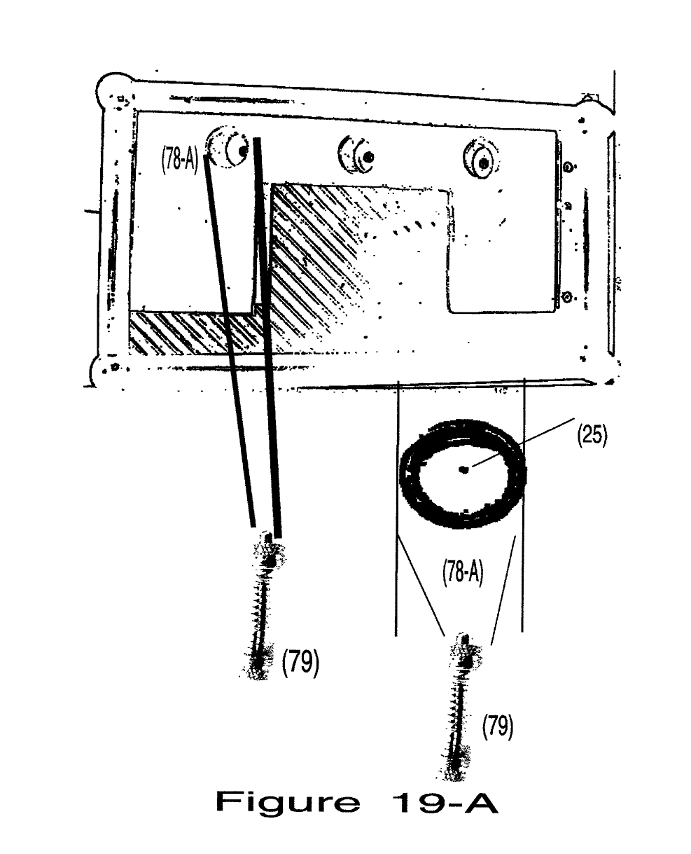

FIG. 19-Illustrates the spring loaded contact assemblies 78 mounted through structure 81 that pass current under spring pressure through the rounded top electrical contact tip 79 to the receiving contacts 25,26,27 of the portable charging unit. The supply wire 80 of each spring loaded contact tip is soldered directly to the tip so as to increase conductivity for maximum current transfer.

The receiving contact points 25, 26, 27 rest directly on the transfer points 31,32,33. When gravity from the weight of the cellular charging unit presses down against the upward pressure created by spring 78 through the rounded head electrical contact tip 79 the current transfer to recharge the cellular charging station and operate the LCD advertising screen 21 occurs without a need to make an electrical contact through a standard clamp assembly or by having to connect the recharging power via a plug and socket.

FIG. 19a-as the charger is made to be used by the general public this system enables any one to achieve a recharging status of the unit simply by getting the charger in the general area as the receiving contact points are arranged to allow a two inch “miss margin” 78-A and still achieve a standard recharge status. This is a vital feature as the general public should not be asked to handle wires or connectors or be required to have a physical dexterity the would require an exact movement to mated electrical contacts. 78-B shows examples of “off target” placement of the cell phone charging station base on the charging station with good excellent operating current transfer still possible.

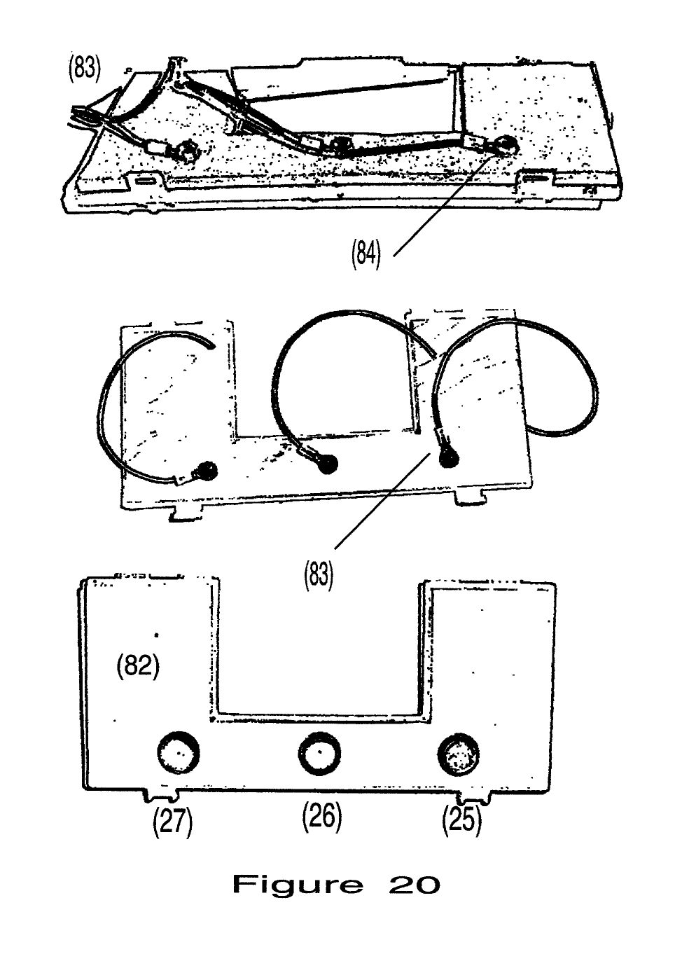

FIG. 20 shows the receiving contacts 27, 26, 25, mounted in the base structure 82 And 83 shows the current transfer wires for charging currents 27-c, 26-c,25c.

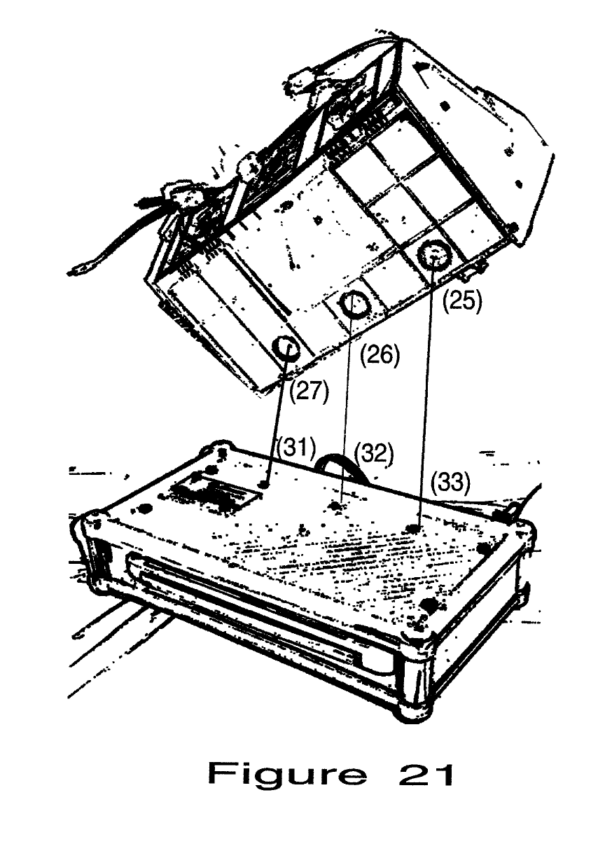

FIG. 21-shows the actual completed assemblies lining up for contact between supply circuits 31,32, and 33, and receipt circuits 27, 26, and 25.

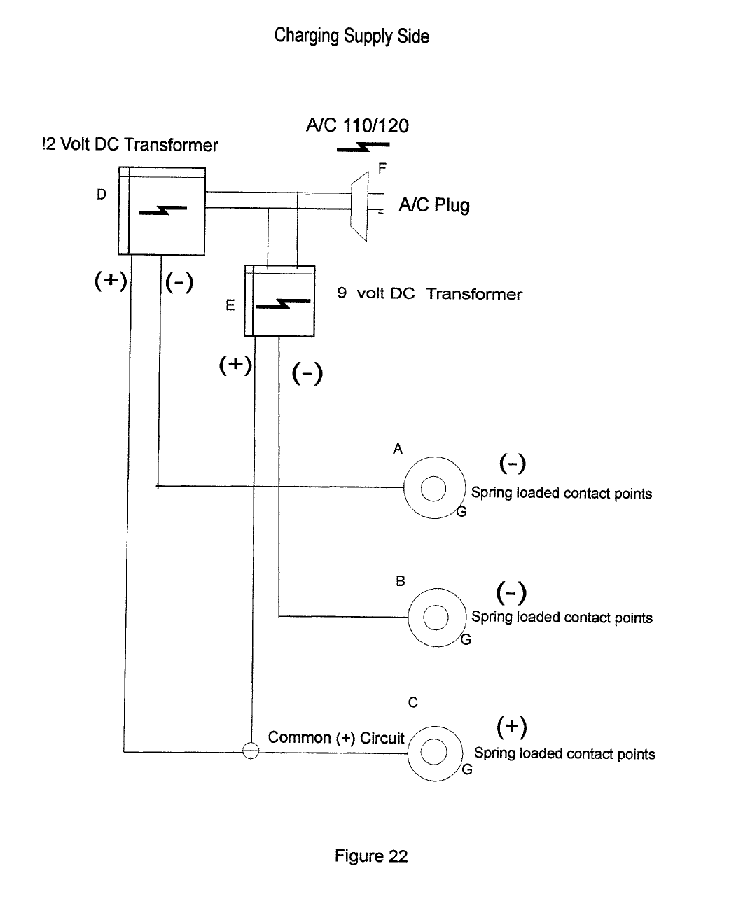

FIG. 22-Is the wiring schematic for the charging base.. 77 is the ac power cord. 74 is the conventional 120/v-12 volt battery charger 1.5 amp battery charger with built in charging status led lights. 75 is the conventional 120/v −8 volt 2 amp conventional power transformer. Power flows from 74 through the plus (+) circuit 31-c to spring assembly 78-a. Power flows from 74 through the negative (−) circuit 33-c to spring assembly 78-c. Power flows from 75-a (+) circuit to common circuit 31-c and 75-b to contact point 32-c. Power flows from 75-b to 32-c supply negative current to power the LCD unit 21.

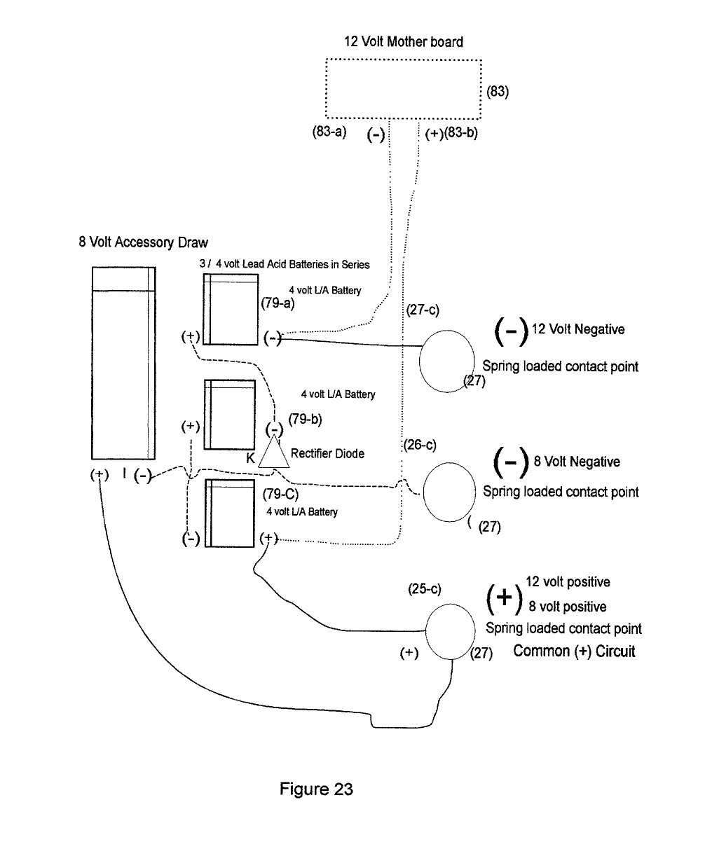

FIG. 23-Is the wiring schematic for the internal power supply for the portable cellular charging station. There are three 4 volt lead acid batteries in series 79-a, 79-b and 79-c. 80 is a rectifier diode allowing voltage to flow from the series group 79-a and 79-b but prohibiting a current flow from 26-c. to act as a charging current to 79-a and 79-b. Instead sending supply current directly to 21 the LCD screen while the cellular recharging unit is seated on it's docking station.( See FIG. 6 ). 84 is the negative side of the 79-a and the 79-b series circuit accumulating to a voltage of 8 volts supplying portable power to the LCD screen when the unit is away from the docking station. 25-c shows a common plus (+) terminal shared by power supplies 74 and 75. 27-c is the negative supply current line to recharge the series of batteries 79-a, 79-b and 79-c and 25-c is the positive supply current line. 83-a is the negative supply line to the cellular recharging station motherboard and 83-b is the positive supply line together supplying power between 7 and 34 amps at 12 volts or as needed for the specific situation or usage demand.. All items 77, 74, 75, 79 and 83 are variable in terms of voltage and amperage according to the needs and usage demand, as well as the standards of electrical supply as are varied throughout the country. That is to say that the supply voltage at 77 might call for a 220 volt supply in Europe. Also the LCD unit 21 may call for a different supply voltage which would then be supplied by a different combination of supply batteries 79-a, 79-b,-79-c or more if need to accommodate higher or more exact voltage supply needs.

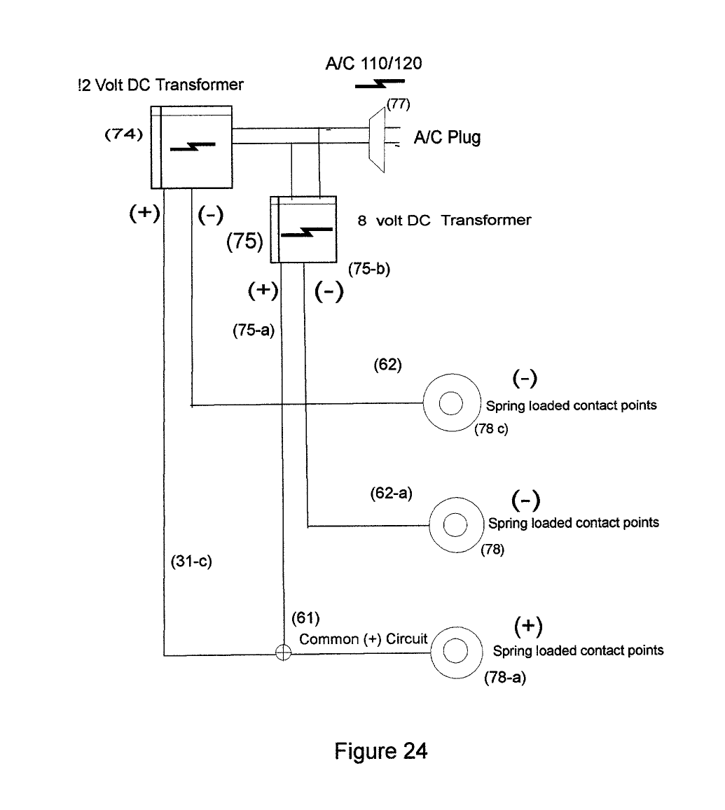

FIG. 24-Is the wiring schematic for the charging base.. 77 is the ac power cord. 74 is the conventional 120/v-12 volt battery charger 1.5 amp battery charger with built in charging status led lights. 75 is the conventional 120/v −8 volt 2 amp conventional power transformer. Power flows from 74 through the plus (+) circuit 31-c to spring assembly 78-a. Power flows from 74 through the negative (−) circuit 62-to spring assembly 78-c. Power flows from 75-a (+) circuit to common circuit 61 and 75-b to contact point 62-a. Power flows from 75-b through circuit 62-a supply negative current to power an auxiliary accessory or LCD unit 21. through contact point 78.

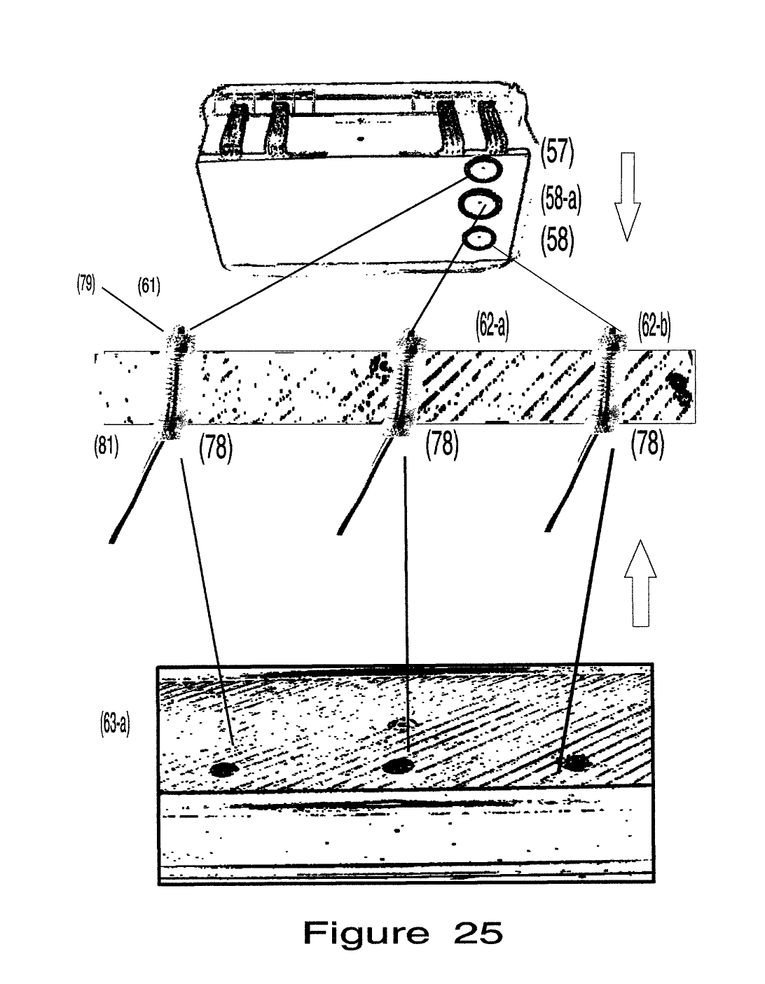

FIG. 25-Is an exploded view of the charging block located in 36 the cellular booth Further Illustrated are the spring loaded contact assemblies 78 mounted through structure 81 that pass current under spring pressure through the rounded top electrical contact tip 79 to the receiving contacts 57, 58-a, and 58 of the removable cellular charging unit.

The supply wire 80 of each spring loaded contact tip is soldered directly to the tip so as to increase conductivity for maximum current transfer.

The receiving contact points 57, 58-a and 58 push directly on the transfer points 61, 62-a and 62-b to make electrical current transfer possible.

When the cellular charging unit presses against the upward pressure created by spring 78 through the rounded head electrical contact tip 79 the current transfer to recharge the cellular charging station and operate the LCD advertising screen 21 occurs without a need to make an electrical contact through a standard clamp assembly or by having to connect the recharging power via a plug and socket.

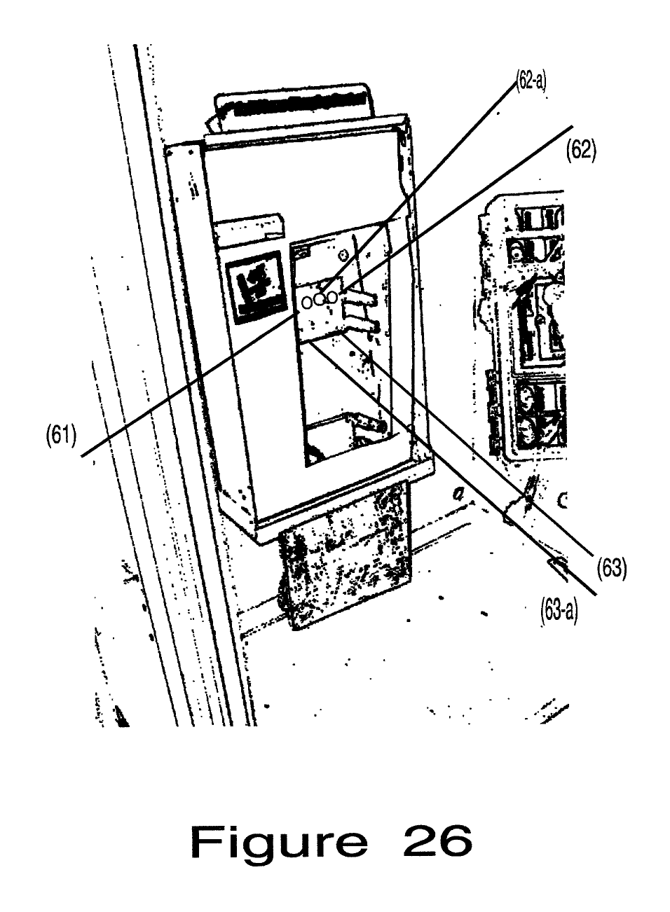

FIG. 26-Shows the negative 62, 62a contact points, the positive contact point 61, The contact charging block 63-a and the female slide support mechanism 63.

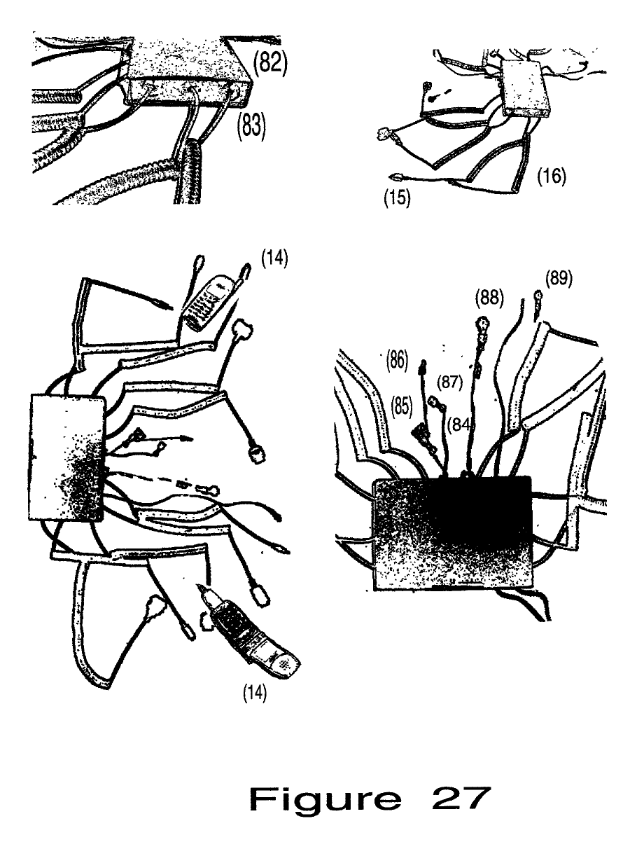

### FIG. 27 Preface

The following illustration describes an “electron reserve of higher capacitance that Builds up an electron reserve of lower capacitance or a “battery that charges a battery” system of supplying emergency recharge power to a plurality of devises of different types with out the need for external A/C power. The cultural demand for cellular phones to be charged in variety of situations and environments required a new solution to a growing problem;

A cellular power recharging source that does not need an external source of power to operate, could handle a multitude of cellular phones and other electronic devices and could be entirely portable. The following illustration describes in detail the “battery that charges a battery” system that answers a universal public need to recharge a wide variety of cellular phones via a totally portable and public friendly device.. This invention takes advantage of the natural laws of capacitance, wherein a higher capacity electron reserve will seek a method of equalizing a lower capacity reserve through electron interchange. This is a water seeks it's own level concept but with electrons instead of water droplets. In building this invention I came across a new and startling discovery that rigorous, “in the field testing has consistently supported”. The following combinations of matter and circuitry creates a very new and useful phenomenon. A safe and reliable means of fast charging cellular phones in public. The following described combinations of matter and circuitry uses the principal of newly released energy from a much higher capacitance reserve to a much lower capacitance reserve creates a greatly accelerated electron exchange between the higher and lower capacity potentials. Just as a flashlight shines brightest when first turned on this circuitry creates an abundant source of fast charge, fast release electron energy by allowing the capacitance to build in the supply battery after a timed charging cycle. That is to say the phenomenon of stored up electrons in an electron reserve brought up to a predetermined surge capacitance by limiting the time of electron release during it's last charging cycle and then purposely interrupting electron flow between consumer uses, and allowing the electron reserve to build back up for re-releases creates the unexpected benefit of faster recharging of cellular phones in the field. By taking advantage of today's high amperage, yet compact sized emergency supply battery cells to energize this portable recharging circuitry, cellular phone users are now able to take advantage of this unexpected but very useful surge of power phenomenon enables a faster charge of cellular phones in the out in the public arena. This of course is of great benefit to a society that is much on the go!

FIG. 27-

82 is an illustration of the motherboard housing. 83 shows the wiring being supported by the side walls of the housing 82 .Holes drilled in the side walls separate and support the charging cord wires 16 that are equipped with various types of cellular phone and other electronic devise charging cord connectors 15 made to fit their companion model phone or device 14 according to manufacturer specifications. D/C power is supplied to the mother board by wiring harness 84 having an in line fuse 85 and both a positive 86 and negative 87 female spade terminal connector for attachment to the D/C power supply battery terminals. 88 is the timer activator switch initiating the timing cycle and 89 is charging when lit light to indicate charging is occurring

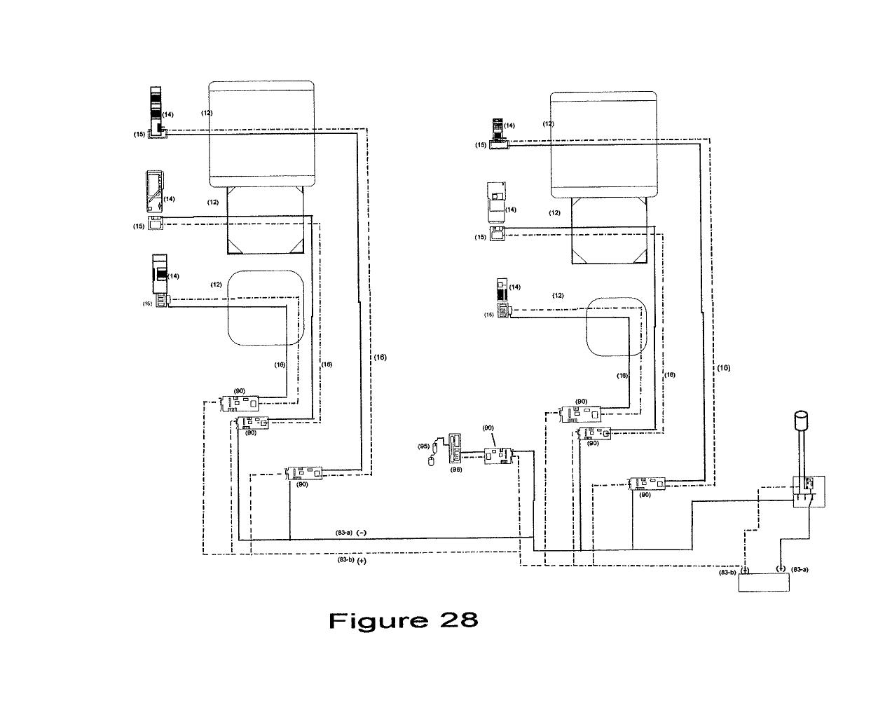

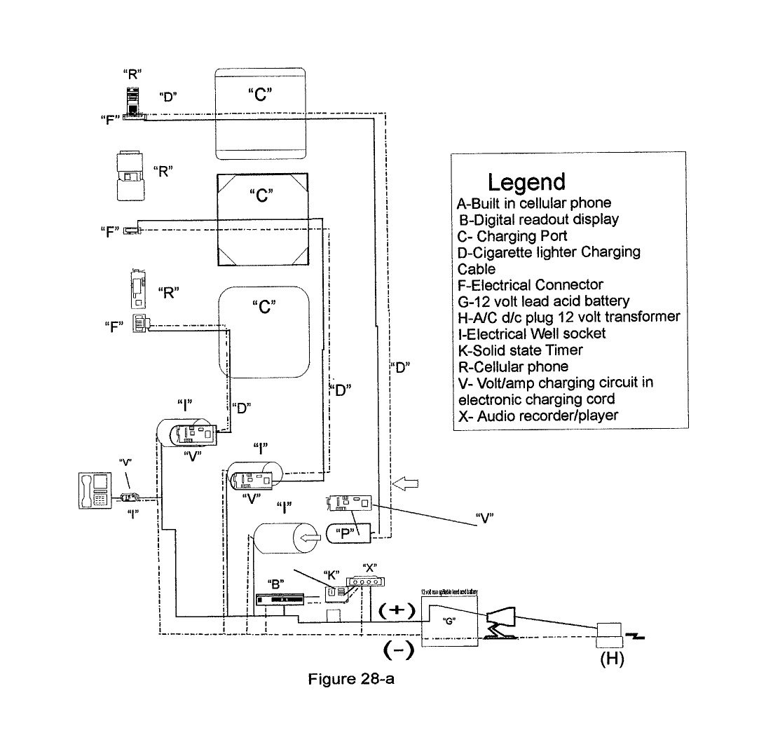

FIG. 28-shows a schematic drawing of the motherboard circuitry 91 .Power supplied by circuit 83-a is routed to the plus (−) terminal of a one shot electronic timer 84 set, for example, a 15 minute time cycle. 83-b is routed to the (+) terminal of 84. The switch terminals 85 and 86 are wired to momentary switch 88. When switch 88 is activated by a customer current is electronically switched on for a specified period of time which allows current to pass onto a plurality of parallel circuits each directly energizing it's own mini-charging circuitry 90. From there the electronically regulated supply voltage and amperage is passed on to 16 for mechanical contact conversion through 15 and onto 14 a cellular phone or electric device that is compatible with that circuits' output voltage and amperage. After a charging cycle is complete, the supply power created by 79-a, 79-b, and 79, c is allowed to build up it's surge energy for a greater or lesser time until the next use by a person needing to recharge their cellular phone or electronic devise activate the timing cycle. 95 is an optional headset for making phone calls and 96 is the e-911 cellular unit for sending e-911 tracking signals and calling in an emergency.

FIG. 28-a Shows a schematic drawing incorporating into the circuitry a card swipe system of activation with promotional message equipment displaying both audio and visual messages.

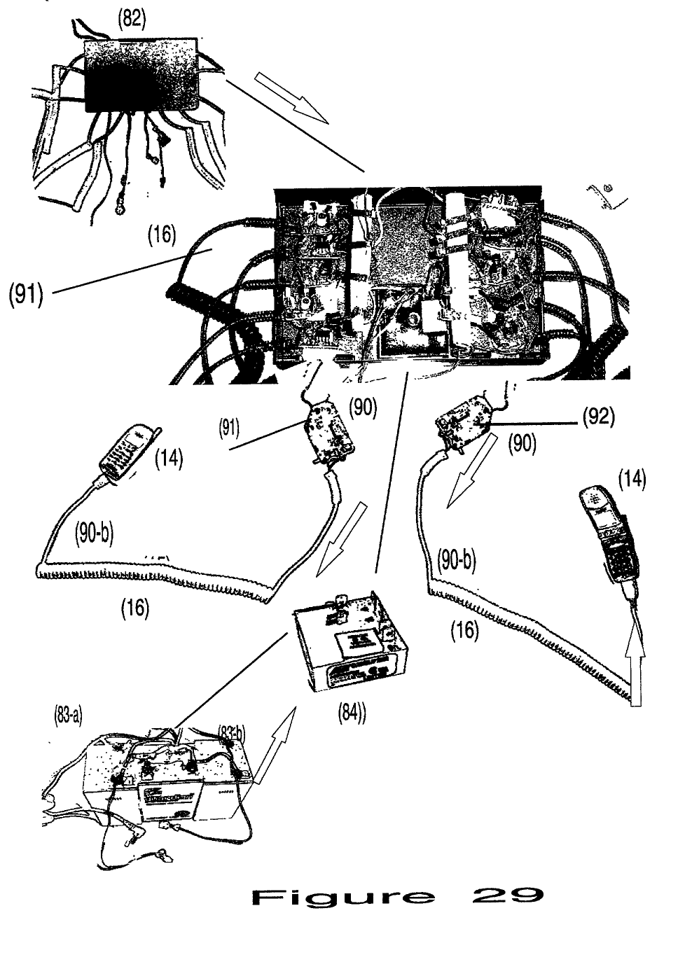

FIG. 29-shows an illustration of the components supporting the motherboard circuitry Power supplied by power source 83-a and 83-b is timed by timer 84 and distributed through conventional mini-charging circuitry 90 that regulates power distribution through cable 16 onto and through connector 15 and into device 14 wherein many types of external batteries may be charged via a higher to lower capacity electronic discharge. circuit 90, comprising a voltage regulating device 91 for distributing the proper voltage specifically regulated according to manufacturers specifications, as well as and a charging regulating i/c chip 92 to prevent over charging according to manufactures specifications. This regulated voltage is then distributed through the charging cord 16 through the proper connector 15 and on to charge the model phone 14 specified as compatible by the manufacturer of 90 for that particular charging circuits' capacities.

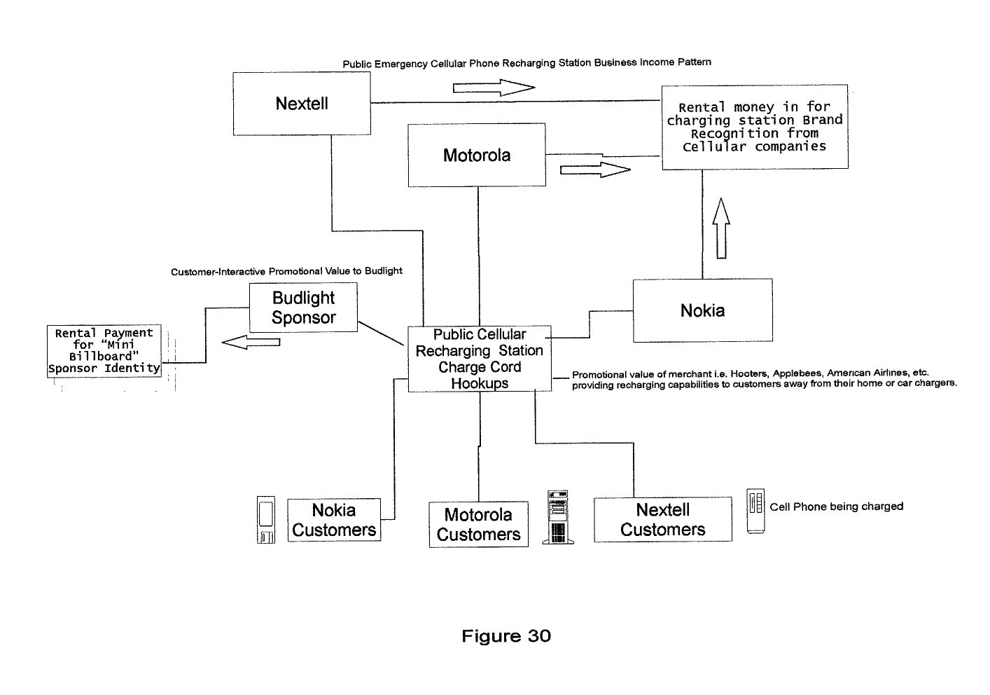

FIG. 30-Shows a flow chart that explains the collective sponsorship cycle enabling the cellular charging stations be sponsored financially so as to enable a much faster distribution into society thus making this public utility much more readily available.

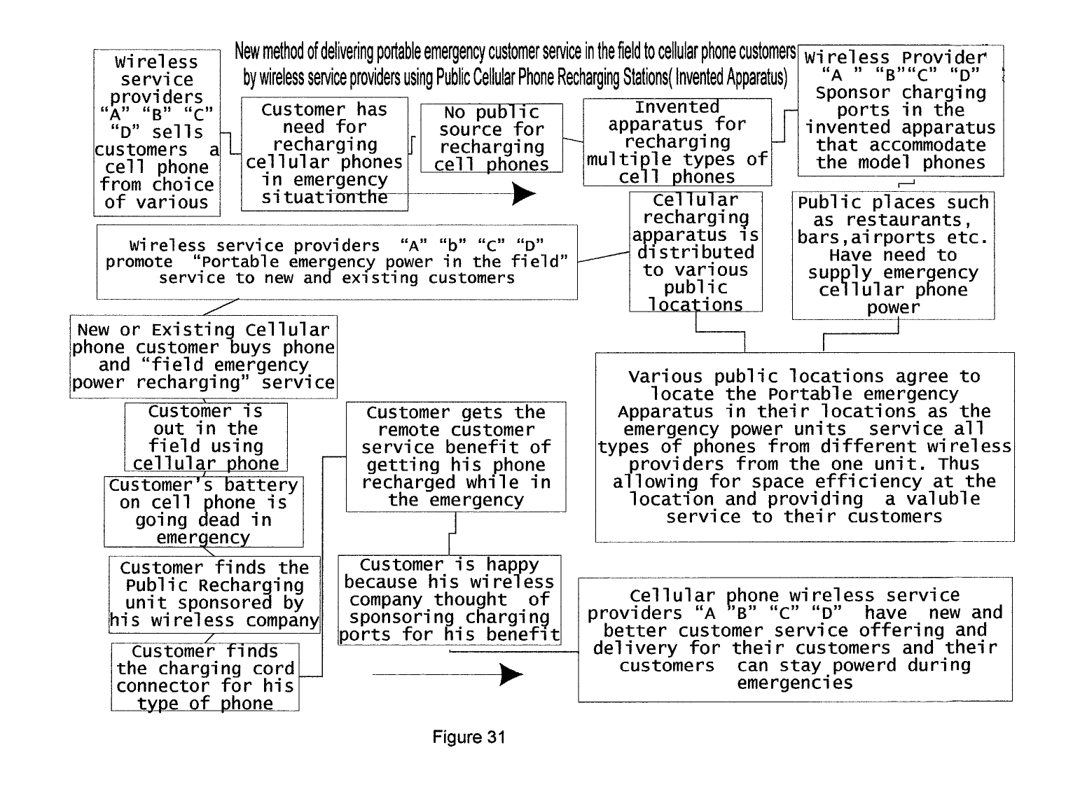

FIG. 31-Shows how the invention allows cellular phone companies to collectively deliver an extension of customer service out in the field being able to deliver recharge energy to many different people using many different services and many different phones all from one space saving housing.

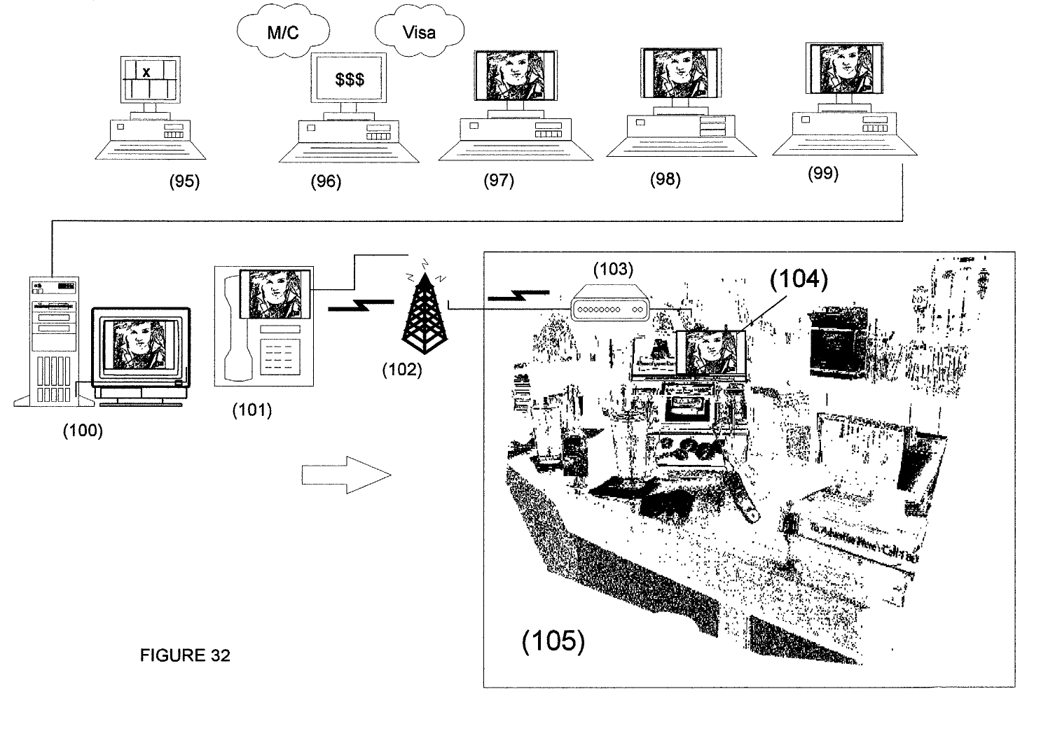

FIG. 32-Shows the new system of remote electronic billboard advertising. This This is an entirely new medium of advertising in that its billboards are completely programmable from a remote location and then are completely portable at the location. This is the ultimate breakthrough in billboard advertising in that then advertising is able to be moved constantly to enable view ability and in actual use within the cellular charging station, the customers actually go over ad pick up the ad display and bring it to their immediate view during a phone recharging cycle. The typical cycle would run as shown in FIG. 32. 95 is the customer selecting the locations were he done by the advertising service provider. 99 is the proofing step wherein the edited graphics arte proofed and approved by the customer. 100 is step of transmitting the image via cellular phone to the cellular tower system 102. 103 is the onboard cellular receiver and CPU for receiving and regenerating the image. 104 shows the image recreated and being displayed on a portable cellular phone recharging station and 105 shows the entire result in a bar. Advertisements being displayed on screen can include movie trailers with sight and sound as well as full sight and sound commercials such as beer advertisements.

FIG.: 33 Shows 97 the_FCC mandate to expand e-911 capabilities. 98 shows a person using the e-911 feature in public.99 shows the tracking of the location. 100 is the emergency dispatching of help.

ADDITIONAL EMBODIMENTS

Inherent in the design of the invention itself are the qualities the enable is use in many other types of situations and embodiments. For instance units can be installed in airplanes, busses, trains, subways, taxi cabs, limousines, or at amusement parks or movie theaters wherein they can be located in lockers and locked up while the person enjoys the park or the movie and when he comes back his phone is charged without risk of theft. Various housings for the unit can be envisioned including shapes of football helmets or beer cans to house the unit for marketing reasons. However it is has been encased, it's purpose and the need it fills, will still be a vital one for society within the framework of the reasons already cited. In some instances, the invention may utilize a card swipe or other method of payment which could be collected at the discretion of the owner of the charging unit at that particular location. However, inherent in the design is the remote billboard feature that makes sponsorship the best way to make the unit free for all to use in times of need or emergency. This is of course, the very essence of the invention. In any case, a payment override feature could be easily incorporated into the circuitry for emergency use without the need for payment being necessary, in any case, the e-911 calling ability would naturally, always be free.

FURTHER PUBLIC SAFETY ADVANTAGES

From the above description a number of public safety advantages of the public cellular charging station become evident:

(a) the ability to supply such portable cellular power can enable a person confined to a wheel chair the convenience of having his phone recharged without having to wheel up to an inconvenient A/C plug that may have blocked wheel chair access.

(b) the housing being equipped with adverting panels can be outfitted with emergency lifesaving techniques such as CPR if full graphic detail in areas where advertising would be better substituted for emergency procedure such as poolside at a resort.

(c) The built in emergency cellular phone enables children or persons not owning a cellular phone a way to make a e-911 call sending help without the need for being able to exactly descried their cellular location.(e-911 utilizes GPS tracking from the cellular signal). Further, such persons, for example being robbed at restaurant, could simply push the e-911 button on the unit and summons help without bringing attention to a conventional cellular phone. Another very important and wide spread cultural benefit to the cellular phone chargers being spread throughout the city so conveniently (without the need to install them in a restrictive fixed location) is that any public place; restaurant, school, hospital, amusement park, movie theater, hotel, bus or train station, airport etc. can easily supply an e-911 portable cellular phone station and provide a further link to the “grid of safety” that enables emergency authorities the ability to track e-911 emergency transmissions to within 50 yards of an emergency, greatly increasing the chances of survival of the victims of an emergency in times where the ability to speak to a e 911-operator is impossible or suppressed.

WHAT IS ENHANCED 911?

When a caller dials 911, the address and phone number of the caller is displayed on a screen at the 911 center. Enhanced 911 or E911 provides dispatchers with the location of callers and their phone number. This is also known as ANI/ALI—automatic number information and automatic location information.

THE PROBLEM

Sounds simple but when you factor in wireless and cellular calls the issue of location gets a bit tricky. Currently, many 911 centers don't receive important location data from wireless telephone calls. This results in confusion and problems for emergency dispatch services. Also, areas that have multiple 911 centers may have problems routing calls as a result of insufficient location data.

Wireless E9-1-1 is one of the most pressing challenges facing the nation's public safety community. Roughly 25% to 30% of all E9-1-1 calls are currently placed from wireless phones, and this percentage is expected to increase sharply as wireless phone usage continues to accelerate over the next few years.

So, What's Being Done?

The FCC has ordered cellular carriers to address the issue in an effort to help 911 centers. Phase I of the FCC plan requires carriers to transmit a number for each call. If additional information is required, the dispatcher can call the number and obtain ‘rough’ locational information about the caller. The second phase requires more precise location data to be transferred with the call, allowing dispatchers to trace the callers location to within 410 feet. Under the current plan, cellular companies have until Oct. 1, 2001 to add this capability.

Phase 1 Requirements (by Mar. 1, 1998)

Wireless service providers were required by the FCC to have the capability to send wireless 911 calls to an E911 PSAP containing two important sets of data (presuming the 911 jurisdiction has implemented a cost recovery mechanism for the carrier and has requested the service):

The location of the cell tower through which the E911 call was processed. The mobile dialing number (MDN) or “call back number” of the wireless phone placing the 911 call.

Phase 2 Requirements (by Oct. 1, 2001)

Wireless service providers are required by the FCC to have the ability to send the actual caller's location (to within 410 ft. of accuracy, 67% of the time) to the E911 PSAP (presuming the 911 jurisdiction has implemented a cost recovery mechanism for the carrier and has requested the service).

This invention will greatly benefit the FCC'S goal of providing a much more effective e-911 system for society

OPERATION

In operation the invention works as shown in FIG. 7-A cellular phone or portable electronic devise user finds a need to have his/her phone recharged because his battery is low. The invention is located at a restaurant, airport boarding area, bar, hospital waiting room or any number or possible locations either fixed or mobile such as a plane train bus taxi limo etc. and he/she has some time before they need to board the plane etc.. Referring now to FIG. 2. The user can go up to the invention. locate the proper charging cord 16 to fit his model phone 14 and plug it in. They would then press the start button 88 and start the charging cycle. In a payment housing scenario The power is turned on by the cellular user by credit card swipe/manufacturer supplied access code/coin deposit, etc. to activate the charging station timer, thus starting the charging cycle. The user would allow his phone to charge as long as he wanted to up through a full charge cycle of approximately 15-30 minutes. They would then remove it from the charging cord 16 and the unit would be ready for a new user who would simply repeat the cycle.

OPERATION PROMOTIONAL INNOVATIONS

Instead of a payment being made for the cellular charging station use it is also possible a sponsor of the would “pre-pay for customer use time” and allow free access to customers as a promotional/goodwill action. Referring to FIG. 32-Shows the new system of remote electronic billboard advertising. This is an entirely new medium of advertising in that its billboards are completely programmable from a remote location and then are completely portable at the location. This is a large breakthrough in billboard advertising in that then advertising is able to be moved constantly to enable view ability and in actual use within the cellular charging station, the customers actually go over ad pick up the ad display and bring it to their immediate view during a phone recharging cycle. The typical cycle would run as shown in FIG. 32. 95 is the customer selecting the locations were he would like to advertise on-line. 96 is securing payment for the ad service. 97 is the submission of the ad artwork via e-mail. 98 is the ad graphics correction or censuring step done by the advertising service provider. 99 is the proofing step wherein the edited graphics arte proofed and approved by the customer. 100 is step of transmitting the image via cellular phone to the cellular tower system 102. 103 is the onboard cellular receiver and CPU for receiving and regenerating the image. 104 shows the image recreated and being displayed on a portable cellular phone recharging station and 105 shows the entire result in a bar. being displayed on screen can include movie trailers with sight and

Following are some examples of some innovative promotional aspects of the invention The EVM has the flexibility of having “multiple charging bays 12 in different quantities i.e. six, nine, twelve or more bays per unit. In addition to accommodating higher traffic use, “extra bays as needed” allow participating manufacturers to service as many model phones as may be needed to satisfy their customer base.

The invention provides participating cell phone manufacturers or wireless service providers a brand new avenue to provide additional service to its users thus potentially gaining a marketing edge over non-participating manufacturers. An additional feature of the invention is that the mother board circuitry is easily changeable that new model phones circuitry can be added easily without having to dispose the entire circuit board. Making it economical to keep up with the times technologically. Additionally, with the mini promotional message spots in each of the charging bays, adding or promoting new technology is as easy as changing sign in a display.

An additional aspect of innovation promotionally speaking is brought about through the use of the invention. The value to the charging station “mini-billboard” sponsor cannot be underestimated. Because of the “interactive” quality to the promotion, i.e. the customer hooking up his cell phone and then monitoring it, and the “direct benefit” to the customer aspect to the promotion (he gets his phone charged up) the sponsor receives more intensified exposure to their message by customers, than say, the quality of attention given to ordinary point of purchase displays or signage.

The unit can be further adapted to features a “Brand Use” sensing device that determines what brand phone is being charged up which triggers a predetermined, (by advertiser) message which is electronically displayed by digital readout, or printed at the point of use by a computer driven means. The message can be changed “on-line” through a modem apparatus that automatically dials up a data center when the devise is used allowing new messages to be downloaded remotely by the advertiser FIG. 32.

EMERGENCY OPERATION

FIG. 9-Is an illustration of a cellular charging station with an emergency breakaway system enabling the public or authorities the ability to remove a portable charging unit from it's public housing in order to service a remote emergency situation.. 36 is a another embodiment of the invention designed to be installed in more general public areas of society such as locations commonly housing public pay phones. 37 is a release lever over the emergency release mechanism FIG. 10-Shows a side perspective as well as a front view. FIG. 11-Illustrates the first step in releasing the portable emergency power unit from it's housing to be taken for emergency use. 36 points to the housing 37 points to the release lever mechanism and 38 shows the push up action of the mechanism that allows the charging unit to be released. FIG. 12-Illustrates the second step in releasing the portable emergency power unit from it's housing to be taken for emergency use. 36 points to the housing 37 points to the release lever mechanism and 39 shows the push in action of the mechanism that allows the charging unit to be released. FIG. 13-Illustrates the third step in releasing the portable emergency power unit from it's away to the emergency situation. housing 36 to be taken for emergency use. 37 points to the release lever mechanism and 40 shows the pull out action of the mechanism that allows the charging unit to be released from the housing. FIG. 14-Illustrates the third step in releasing the portable emergency power unit from it's housing to be taken for emergency use.. 36 points to the housing 37 points to the release lever mechanism and 41 shows the person taking the unit

CONCLUSIONS, RAMIFICATIONS, AND SCOPE

While my above description contains many specifications, these should not be construed as limitations on the scope of the invention, but rather as examples of preferred embodiments thereof. Many other variations are possible. For example the invention being a portable communications devise can serve not only as an emergency source of communication and energy support for society, but the scope of its attributes allow many adaptations that could easily be adapted to a portable public communications station for example that could be made available on busses, trains subways taxis etc. for business or family communication convenience, but could as well serve as a means of contacting advertisers for remote interactive purchasing via a voice or touch screen, or further adapted to allow remote pubic video conferencing while mobile or while seated at a restaurant table.

Further, the invention allows for changes in materials or external ornamental design in order to fit any environment whether in the finest hotel lobby, or in the waiting area of a bus terminal. It allow as for immediate and broad distribution by having the ability to be placed anywhere because of it's portability, convenient size and shape, and the fact that it requires no more skill to install or use than that needed to plug in a table lamp and push a door bell button. The companion charging base requires no special wiring and can be adapted to be plugged into any conventional power mains this feature makes every establishment a candidate to sponsor an emergency charging and e-911 unit!

I claim:

1-A method of increasing public safety by supplying widespread portable power to the general public in order to recharge their cellular phones while providing the tracking coordinates of it's users to e-911 authorities during emergencies or disasters comprising:.
(a) The method of claim 1 wherein is a portable public emergency power supply devise capable of recharging cellular phones is utilized and made available to the general public for recharging or operating cellular phones
(b) The method of claim 1 wherein, the devise is distributed to the general pubic in an embodiment capable of being moved around by the general public.
(c) The method in claim one wherein a docking station is provided capable replenishing power to said devise while not in use
(d) The method in claim one of activating said device for a cellular phone recharging cycle for non-emergency use for public convenience or cellular power readiness for anticipated emergency
(e) The method in claim 1 of activating a cellular phone recharging cycle for emergency use
(f) The method of claim 1 wherein said devise is equipped with at least one-911 cellular transmitting and receiving device.
(g) The method in claim one of activation an e-911 tracking cycle via the said device
(h) The method of claim 1 wherein the availability and distribution of said device is sponsored by promotional sponsors
(i)-The method of claim 1 where said devise is capable of receiving sponsorship message transmissions via a wireless information receiving system built into said devise
(j)-The method of claim 1 where in said transmission is converted to a static graphic image with no sound and displayed on an electronic display screen for the purpose of relaying sponsor messages to the public
(k)-The method of claim 1 wherein said transmission is converted to a motion picture image with sound for the purpose of relaying sponsor messages to the public.
(l)-The method in claim 1 were in a customer receiving said sponsor messages could respond with a purchase order by selective touch screen, voice or two way video conferencing means.

2-A portable public utility devise capable of supplying emergency power to the public for the purpose of recharging or operating cellular phones and providing e-911 tracking information to authorities to summons help.
(a) In accordance with claim 2: A portable method of converting a reserve of electrical energy to different useful regulated voltages and amperages via recharging circuitry conducive to a variety of popular cellular phones or other electronic devises for emergency purposes.
(b) In accordance with claim 2, a means to supply said regulated recharging energy to, a variety of power connectors conducive to different model cell phones
(c) In accordance with claim 2, a means to supply said regulated recharging to variety of connectors conducive to different models of electronic devices
(d) In accordance with claim 2, a means of timing the use of said recharging power
(e) In accordance with claim 2, an article of manufacture that houses said means of supplying electrical energy
(f) In accordance with claim 2, an article of manufacture that supplies recharge power to said device in described in claim 2
(g) In accordance claim 2, an article of manufacture that houses the portable unit while not in use wherein a release mechanism is utilized to allow the portable unit to be carried from its housing to an emergency situation,
(h) In accordance with claim 2 a method of recharging said unit while it is docked in said housing.
(i) In accordance with claim 2, an e-911 transmitting and receiving device capable of sending e-911 tracking signals and voice communication.
